(19) United States
(12) Patent Application Publication
(10) Pub. No.: US 2018/0047193 A1
(43) Pub. Date: Feb. 15, 2018

(54) ADAPTIVE BOUNDING BOX MERGE METHOD IN BLOB ANALYSIS FOR VIDEO ANALYTICS

(71) Applicant: QUALCOMM Incorporated, San Diego, CA (US)

(72) Inventors: Jinglun Gao, Milpitas, CA (US); Ying Chen, San Diego, CA (US); Lei Wang, Clovis, CA (US); Ning Bi, San Diego, CA (US)

(21) Appl. No.: 15/285,441

(22) Filed: Oct. 4, 2016

Related U.S. Application Data
(60) Provisional application No. 62/375,319, filed on Aug. 15, 2016.

(51) Int. Cl. G06T 11/60; G06T 7/60

(52) U.S. Cl. CPC G06T 11/60; G06T 7/60; G06T 2210/12

(57) ABSTRACT

Provided are methods, apparatuses, and computer-readable medium for content-adaptive bounding box merging. A system using content-adaptive bounding box merging can adapt its merging criteria according to the objects typically present in a scene. When two bounding boxes overlap, the content-adaptive merge engine can consider the overlap ratio, and compare the merged bounding box against a minimum object size. The minimum object size can be adapted to the size of the blobs detected in the scene. When two bounding boxes do not overlap, the system can consider the horizontal and vertical distances between the bounding boxes. The system can further compare the distances against content-adaptive thresholds. Using a content-adaptive bounding box merge engine, a video content analysis system may be able to more accurately merge (or not merge) bounding boxes and their associated blobs.

### CROSS-REFERENCE TO RELATED APPLICATIONS

This application claims the benefit under 35 U.S.C. §119 of Provisional Patent Application No. 62/375,319, filed on Aug. 15, 2016, the entirety of which is incorporated by reference herein.

### FIELD

The present disclosure generally relates to video analytics, and more specifically to techniques and systems for content-adaptive merging of bounding boxes to merge blobs that are associated with one object, and not merge blobs when the blobs are not associated with one object.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. In some cases, video analytics can send alerts or alarms for certain events of interest. More advanced video analytics is needed to provide efficient and robust video sequence processing.

### BRIEF SUMMARY

In some embodiments, techniques and systems are described for content-adaptive merging of bounding boxes in video analytics. A bounding box provides information about a blob, such as the location in a frame of the blob and the approximate size of a blob. A blob represents at least a portion of one or more objects in a video frame (also referred to as a “picture”). In some cases, one object may be detected as two or more blobs in a video frame. A video content analysis system thus generally includes a bounding box merge process for grouping such blobs, and producing a single bounding box that describes the group of blobs as one object. Without a merge process, blobs that are, in actuality, one object may be tracked as multiple objects, which may produce inaccurate tracking results.

Generally, bounding box merge processes use basic criteria to determine whether two bounding boxes should be merged. For example, a merge process may compare the area in which two bounding boxes overlap against the total area that would result from merging the bounding boxes. Simple criteria such as in this example, however, may fail to merge blobs that do not overlap. Additionally, blobs that should not be merged but that happen to be close to each other may be merged.

In various implementations, a content-adaptive bounding box merge process may more accurately merge, or not merge, bounding boxes. In various implementations, a content-adaptive bounding box merge process can consider not only the amount of overlap between two bounding boxes, but also the distance between the bounding boxes when the bounding boxes do not overlap. The content-adaptive bounding box merge process can further consider the size of a bounding box that may result from the merging of two bounding boxes, and determine whether the size exceeds that of a minimum reasonable object size for the particular scene. Furthermore, criteria such as distance thresholds and the minimum reasonable object size can be adapted for the particular objects typically present in a scene.

According to at least one example, a method for content-adaptive bounding box merging is provided that includes determining a candidate merged bounding box for a first bounding box and a second bounding box. The first bounding box can be associated with a first blob. The first blob can include pixels of at least a portion of a first foreground object in a video frame. The second bounding box can be associated with a second blob. The second blob can include pixels of at least a portion of a second foreground object in the video frame. The candidate merged bounding box can include the first blob and the second blob. The method further includes determining a size of the candidate merged bounding box. The method further includes comparing the size of the candidate merged bounding box against a size threshold. The method further includes determining to merge the first bounding box and the second bounding box based on the size of the candidate merged bounding box being less than the size threshold.

In another example, an apparatus is provided that includes a memory configured to store video data and a processor. The processor is configured to and can determine a candidate merged bounding box for a first bounding box and a second bounding box. The first bounding box can be associated with a first blob. The first blob can include pixels of at least a portion of a first foreground object in a video frame. The second bounding box can be associated with a second blob. The second blob can include pixels of at least a portion of a second foreground object in the video frame. The candidate merged bounding box can include the first blob and the second blob. The processor is configured to and can determine a size of the candidate merged bounding box. The processor is configured to and can compare the size of the candidate merged bounding box against a size threshold. The processor is configured to and can determine to merge the first bounding box and the second bounding box based on the size of the candidate merged bounding box being less than the size threshold.

In another example, a computer readable medium is provided having stored thereon instructions that when executed by a processor perform a method that includes determining a candidate merged bounding box for a first bounding box and a second bounding box. The first bounding box can be associated with a first blob. The first blob can include pixels of at least a portion of a first foreground object in a video frame. The second bounding box can be associated with a second blob. The second blob can include pixels of at least a portion of a second foreground object in the video frame. The candidate merged bounding box can include the first blob and the second blob. The method further includes determining a size of the candidate merged bounding box. The method further includes comparing the size of the candidate merged bounding box against a size threshold. The method further includes determining to merge the first bounding box and the second bounding box based on the size of the candidate merged bounding box being less than the size threshold.

In another example, an apparatus is provided that includes means for determining a candidate merged bounding box for a first bounding box and a second bounding box. The first bounding box can be associated with a first blob. The first blob can include pixels of at least a portion of a first foreground object in a video frame. The second bounding box can be associated with a second blob. The second blob can include pixels of at least a portion of a second foreground object in the video frame. The candidate merged bounding box can include the first blob and the second blob. The apparatus further comprises means for determining a size of the candidate merged bounding box. The apparatus further comprises means for comparing the size of the candidate merged bounding box against a size threshold. The apparatus further comprises means for determining to merge the first bounding box and the second bounding box based on the size of the candidate merged bounding box being less than the size threshold.

In some aspects, the methods, apparatuses, and computer readable medium described above further comprise determining that the first bounding box and the second bounding box have an intersecting region and a non-intersecting region, determining a ratio between an area of the non-interesting region and the intersecting region, and comparing the ratio to an overlap threshold. In these aspects, determining to merge the first bounding box and the second bounding box is further based on the ratio being less than the overlap threshold.

In some aspects, the methods, apparatuses, and computer readable medium described above further comprise determining a first distance between the first bounding box and the second bounding box and comparing the first distance to a first distance threshold. In these aspects, determining to merge the first bounding box and the second bounding box is further based on the first distance being less than or equal to the first distance threshold. In some aspects, the methods, apparatuses, and computer readable medium described above further comprise determining a second distance threshold between the first bounding box and the second bounding box. In these aspects, the second distance is orthogonal to the first distance (e.g., if the first distance is horizontal, the second distance is vertical). These aspects further comprise comparing the second distance to a second distance threshold. In these aspects, determining to merge the first bounding box and the second bounding box is further based on the second distance being less than or equal to the second distance threshold.

In some aspects, the horizontal distance threshold is zero when the first bounding box and the second bounding box do not vertically overlap. In some aspects, the horizontal distance threshold is a horizontal constant when the size of the candidate merged bounding box is less than or equal to a multiple of the size threshold. In some aspects, the horizontal distance threshold is a fraction of the horizontal constant when the first bounding box and the second bounding box vertically overlap and the size of the candidate merged bounding box is greater than the multiple of the size threshold.

In some aspects, the methods, apparatuses, and computer readable medium described above further comprise determining the horizontal distance threshold. In these aspects, determining the horizontal distance threshold includes selecting a minimum value from among of a previous value of the horizontal distance threshold, a width of the first bounding box, and a width of the second bounding box.

In some aspects, the vertical distance threshold is zero when the first bounding box and the second bounding box do not horizontally overlap. In some aspects, the vertical distance threshold is a vertical constant when the size of the candidate merged bounding box is less than or equal to a multiple of the size threshold. In some aspects, the vertical distance threshold is a fraction of the vertical constant when the first bounding box and the second bounding box horizontally overlap and the size of the candidate merged bounding box is greater than the multiple of the size threshold.

In some aspects, the methods, apparatuses, and computer readable medium described above further comprise determining the vertical distance threshold. In these aspects, determining the vertical distance threshold includes selecting a minimum value from among a previous value of the vertical distance threshold, a height of the first bounding box, and a height of the second bounding box.

In some aspects, the size threshold is a multiple of a minimum object size. In some aspects, the minimum object size is determined using historical bounding box sizes. In some aspects, the minimum object size is configurable.

In some aspects, the methods, apparatuses, and computer readable medium described above further comprise determining, for each pair of bounding boxes in the video frame, whether to merge the pair of bounding boxes.

According to at least one example, a method for content-adaptive bounding box merging is provided that includes determining a horizontal distance between a first bounding box and a second bounding box. The first bounding box can be associated with a first blob. The first blob can include pixels of at least a portion of a first foreground object in a video frame. The second bounding box can be associated with a second blob. The second blob can include pixels of at least a portion of a second foreground object in the video frame. The method further includes determining a vertical distance between the first bounding box and the second bounding box. The method further includes comparing the horizontal distance to a horizontal distance threshold. The method further includes comparing the vertical distance to a vertical distance threshold. The method further includes determining to merge the first bounding box and the second bounding box based on the horizontal distance being less than or equal to the horizontal distance threshold and the vertical distance being less than or equal to the vertical distance threshold.

In another example, an apparatus is provided that includes a memory configured to store video data and a processor. The processor is configured to and can determine a horizontal distance between a first bounding box and a second bounding box. The first bounding box can be associated with a first blob. The first blob can include pixels of at least a portion of a first foreground object in a video frame. The second bounding box can be associated with a second blob. The second blob can include pixels of at least a portion of a second foreground object in the video frame. The processor is configured to and can determine a vertical distance between the first bounding box and the second bounding box. The processor is configured to and can compare the horizontal distance to a horizontal distance threshold. The processor is configured to and can compare the vertical distance to a vertical distance threshold. The processor is configured to and can determine to merge the first bounding box and the second bounding box based on the horizontal distance being less than or equal to the horizontal distance threshold and the vertical distance being less than or equal to the vertical distance threshold.

In another example, a computer readable medium is provided having stored thereon instructions that when executed by a processor perform a method that includes determining a horizontal distance between a first bounding box and a second bounding box. The first bounding box can be associated with a first blob. The first blob can include pixels of at least a portion of a first foreground object in a video frame. The second bounding box can be associated with a second blob. The second blob can include pixels of at least a portion of a second foreground object in the video frame. The method further includes determining a vertical distance between the first bounding box and the second bounding box. The method further includes comparing the horizontal distance to a horizontal distance threshold. The method further includes comparing the vertical distance to a vertical distance threshold. The method further includes determining to merge the first bounding box and the second bounding box based on the horizontal distance being less than or equal to the horizontal distance threshold and the vertical distance being less than or equal to the vertical distance threshold.

In another example, an apparatus is provided that includes means for determining a horizontal distance between a first bounding box and a second bounding box. The first bounding box can be associated with a first blob. The first blob can include pixels of at least a portion of a first foreground object in a video frame. The second bounding box can be associated with a second blob. The second blob can include pixels of at least a portion of a second foreground object in the video frame. The apparatus further includes a means for determining a vertical distance between the first bounding box and the second bounding box. The apparatus further includes a means for comparing the horizontal distance to a horizontal distance threshold. The apparatus further includes a means for comparing the vertical distance to a vertical distance threshold. The apparatus further includes a means for determining to merge the first bounding box and the second bounding box based on the horizontal distance being less than or equal to the horizontal distance threshold and the vertical distance being less than or equal to the vertical distance threshold.

In some aspects, the methods, apparatuses, and computer readable medium described above further comprise determining a candidate merged bounding box for the first bounding box and the second bounding box. In these aspects, the candidate merged bounding box can include the first blob and the second blob. These aspects further include comparing the size of the candidate merged bounding box against a size threshold. In these aspects, determining to merge the first bounding box and the second bounding box is further based on the size of candidate merged bounding box being less than or equal to the size threshold.

In some aspects, the size threshold is a multiple of a minimum object size. In some aspects, the size threshold is a multiple of a minimum object size. In these aspects, the minimum object size is determined using historical bounding box sizes. In some aspects, the size threshold is a multiple of a minimum object size. In these aspects, the minimum object size is configurable.

In some aspects, the horizontal distance threshold is zero when the first bounding box and the second bounding box do not vertically overlap. In some aspects, the horizontal distance threshold is a horizontal constant when the size of the merged bounding box is less than or equal to a multiple of the size threshold. In some aspects, the horizontal distance threshold is a fraction of the horizontal constant when the first bounding box and the second bounding box vertically overlap and the size of the merged bounding box is greater than the multiple of the size threshold.

In some aspects, the methods, apparatuses, and computer readable medium described above further comprise determining the horizontal distance threshold. In these aspects, determining the horizontal distance threshold includes selecting a minimum value from among of a previous value of the horizontal distance threshold, a width of the first bounding box, and a width of the second bounding box.

In some aspects, the vertical distance threshold is zero when the first bounding box and the second bounding box do not horizontally overlap. In some aspects, the vertical distance threshold is a vertical constant when the size of the merged bounding box is less than or equal to a multiple of the size threshold. In some aspects, the vertical distance threshold is a fraction of the vertical constant when the first bounding box and the second bounding box horizontally overlap and the size of the merged bounding box is greater than the multiple of the size threshold.

In some aspects, the methods, apparatuses, and computer readable medium described above further comprise determining the vertical distance threshold. In these aspects, determining the vertical distance threshold includes selecting a minimum value from among a previous value of the vertical distance threshold, a height of the first bounding box, and a height of the second bounding box.

In some aspects, the methods, apparatuses, and computer readable medium described above further comprise determining, for each pair of bounding boxes in the video frame, whether to merge the pair of bounding boxes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present invention are described in detail below with reference to the following drawing figures:

FIG. 1 is a block diagram illustrating an example of a system including a video source and a video analytics system, in accordance with some embodiments.

FIG. 2 is an example of a video analytics system processing video frames, in accordance with some embodiments.

FIG. 3 is a block diagram illustrating an example of a blob detection engine, in accordance with some embodiments.

FIG. 4 is a block diagram illustrating an example of an object tracking engine, in accordance with some embodiments.

FIG. 5 illustrates an example of a simple blob merge case.

FIG. 6A-FIG. 6C illustrate an example where a fixed threshold that was too small caused blobs that should have been merged to not be merged.

FIG. 7A-FIG. 7C illustrate an example where an object is detected as multiple, non-overlapping blobs.

FIG. 8A-FIG. 8C illustrates an example where relying only on a fixed threshold resulted in two blobs that are unrelated being merged.

FIG. 9A-FIG. 9D illustrate examples of various ways in which two bounding boxes may relate to each other spatially.

FIG. 10 illustrates an example of a video analytics system that includes a content-adaptive merge engine.

FIG. 11 illustrates an example of a content-adaptive merge engine.

FIG. 12 illustrates an example of a process that a content-adaptive merge engine can use to determine whether to merge two bounding boxes.

FIG. 13A-FIG. 13D illustrate an example comparing the result from a bounding box merge process that uses fixed thresholds, and the result from a content-adaptive bounding box merge process.

FIG. 14A-FIG. 14D illustrate another example comparing the result from a bounding box merge process that uses fixed thresholds and the result from a content-adaptive bounding box merge process.

FIG. 15A-FIG. 15D illustrate another example comparing the result from a bounding box merge process that uses fixed threshold and the result from a content-adaptive bounding box merge process.

FIG. 16 illustrates an example of a process for content adaptive merging of bounding boxes.

FIG. 17 illustrates an example of a process for content adaptive merging of bounding boxes.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a video sequence from a video source and can process the video sequence to provide a variety of tasks. One example of a video source can include an Internet protocol camera (IP camera), or other video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding box around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of event of interest and sends an alert or alarm to a central control room to alert a user of the event of interest.

As discussed below, tracking an object moving in a scene can include identifying pixels in a video frame that may be associated with the object, and grouping the pixels together into a blob. A bounding box can then be drawn around the blob, to provide information such as the location and approximate size of the blob.

Sometimes one object may be identified as two or more blobs. For example, a person walking across a scene may be wearing clothing that blends with the background, such that the area of the person's torso is identified as background pixels. In this example, the person's head, hands, and feet may be identified as several different blobs. Tracking each of these blobs separately may either provide inaccurate information, or may inaccurately represent what has occurred in the scene.

Because one object may be identified in a video frame as multiple blobs, a video content analysis system can include a bounding box merge process to merge the bounding boxes for a group of related blobs into one bounding box. A bounding box merge process may consider, for example, the amount of overlap between two bounding boxes to determine whether the bounding boxes should be merged. Once the bounding boxes are merged, the blobs associated with the merged bounding boxes can be tracked as one object.

In some cases, two blobs may appear close to each other in a frame, or may overlap. A simple merge process may determine, based on the proximity of the blobs to each other, that the blobs should be merged. In reality, however, the blobs may represent two different objects, and should not be merged. A merge process that examines only the amount of overlap between two bounding boxes may not be able to determine that the bounding boxes are only coincidentally close to each other.

In various implementations, provided is a content-adaptive bounding box merge engine. The content-adaptive bounding box merge engine can adapt its merging criteria according to the objects typically present in a scene. When two bounding boxes overlap, the content-adaptive merge engine can consider the overlap ratio, and compare the merged bounding box against a minimum reasonable object size. The minimum reasonable object size can be adapted to the size of the blobs detected in the scene. When two bounding boxes do not overlap, the content-adaptive merge engine can consider the horizontal and vertical distances between the bounding boxes. The content-adaptive merge engine can further compare the distances against content-adaptive thresholds. Using a content-adaptive bounding box merge engine, a video content analysis system may be able to more accurately merge (or not merge) bounding boxes and their associated blobs. Doing so may further lead to more accurate tracking of moving objects in a scene.

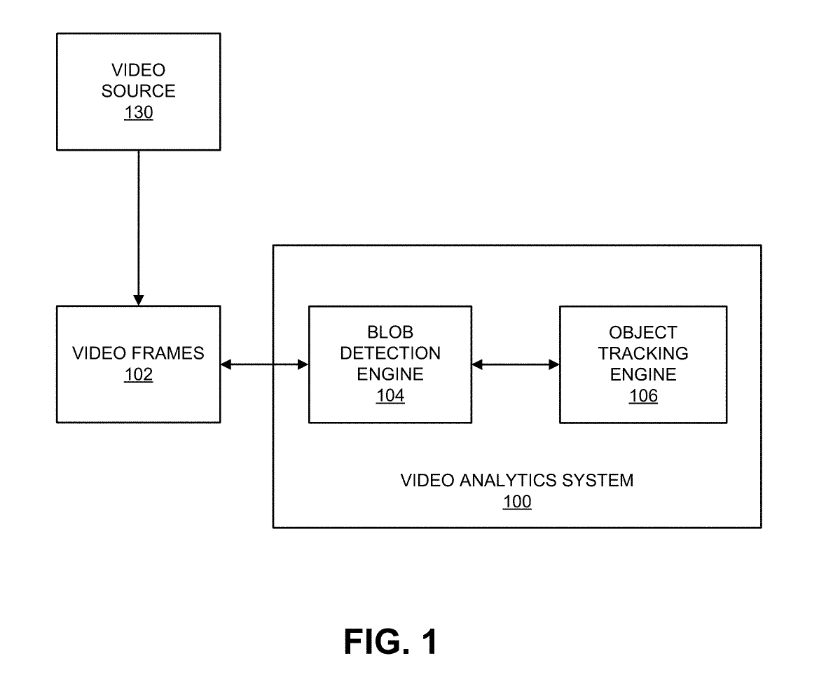

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection engine 104 and an object tracking engine 106. Object detection and tracking allows the video analytics system 100 to provide various end-to-end features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection engine 104 can detect one or more blobs in video frames (e.g., video frames 102) of a video sequence, and the object tracking engine 106 can track the one or more blobs across the frames of the video sequence. As used herein, a blob refers to pixels of at least a portion of an object in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof. In some examples, a bounding box can be associated with a blob. In the tracking layer, in case there is no need to know how a blob is formulated within a bounding box, the term blob and bounding box may be used interchangeably.

As described in more detail below, blobs can be tracked using blob trackers. A blob tracker can be associated with a tracker bounding box can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, a history of the velocity, and a history of locations of continuous frames for the blob tracker, as described in more detail below.

As described in further detail below, a motion model for a blob tracker can determine and maintain two locations of the blob tracker for each frame (e.g., a first location that includes a predicted location in the current frame and a second location that includes a location in the current frame of a blob with which the tracker is associated in the current frame). As also described in more detail below, the velocity of a blob tracker can include the displacement of a blob tracker between consecutive frames.

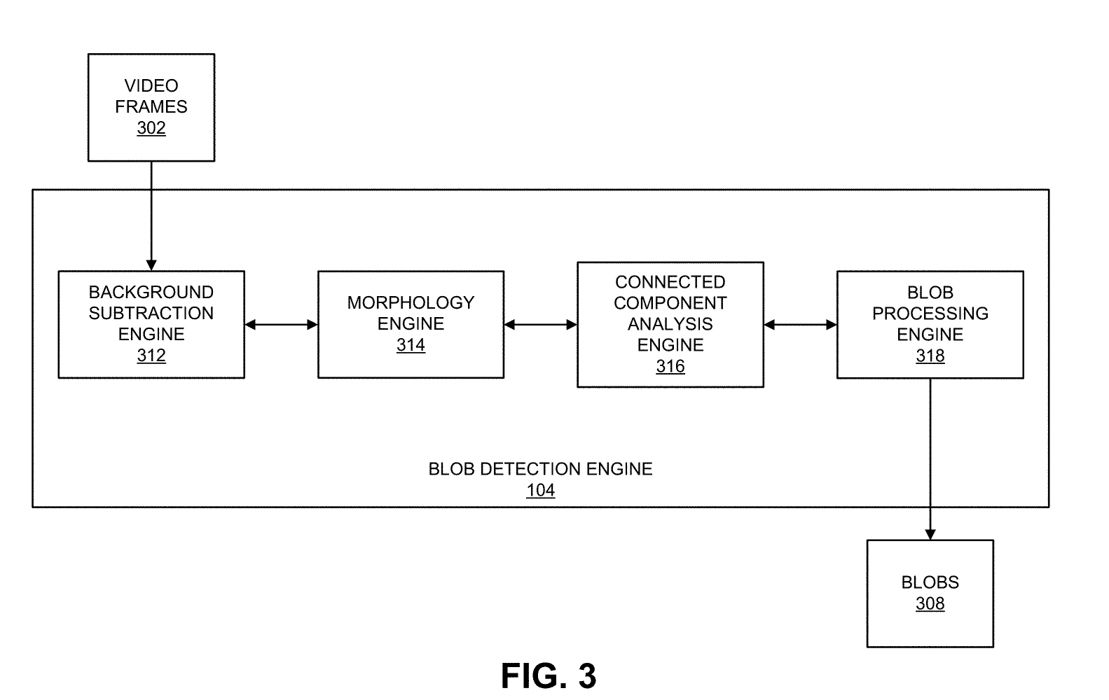

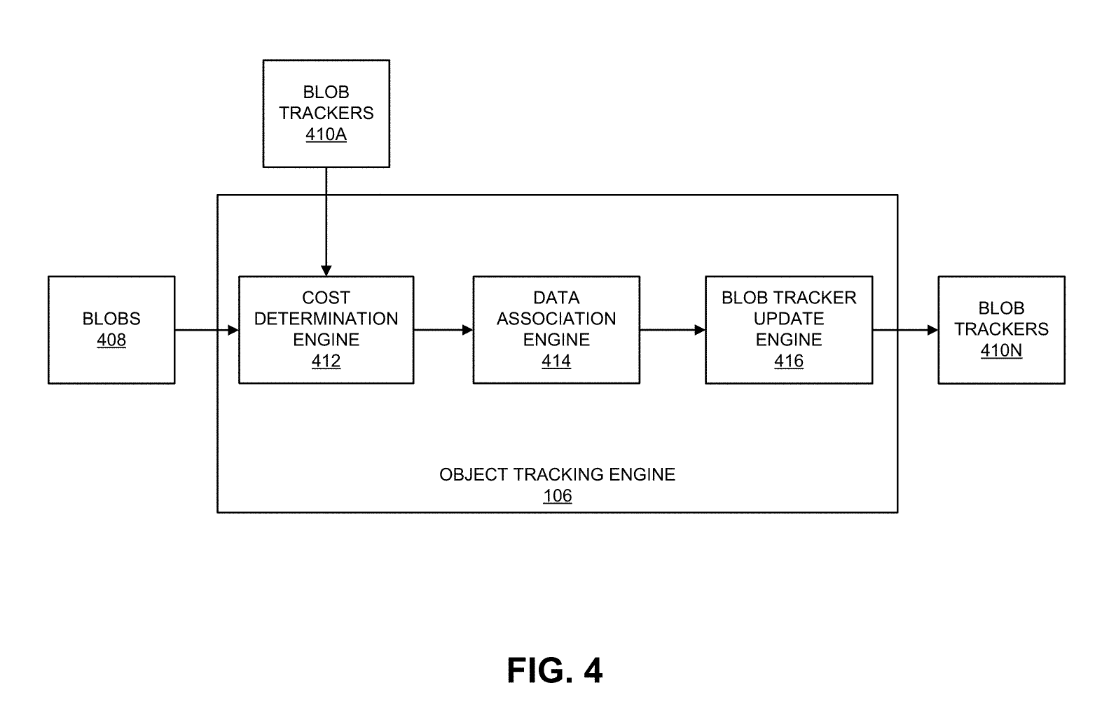

Using the blob detection engine 104 and the object tracking engine 106, the video analytics system 100 can perform blob generation and detection for each frame or picture of a video sequence. For example, the blob detection engine 104 can perform background subtraction for a frame, and can then detect foreground pixels in the frame. Foreground blobs are generated from the foreground pixels using morphology operations and spatial analysis. Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection engine 104 and the object tracking engine 106 are described with respect to FIGS. 3-4.

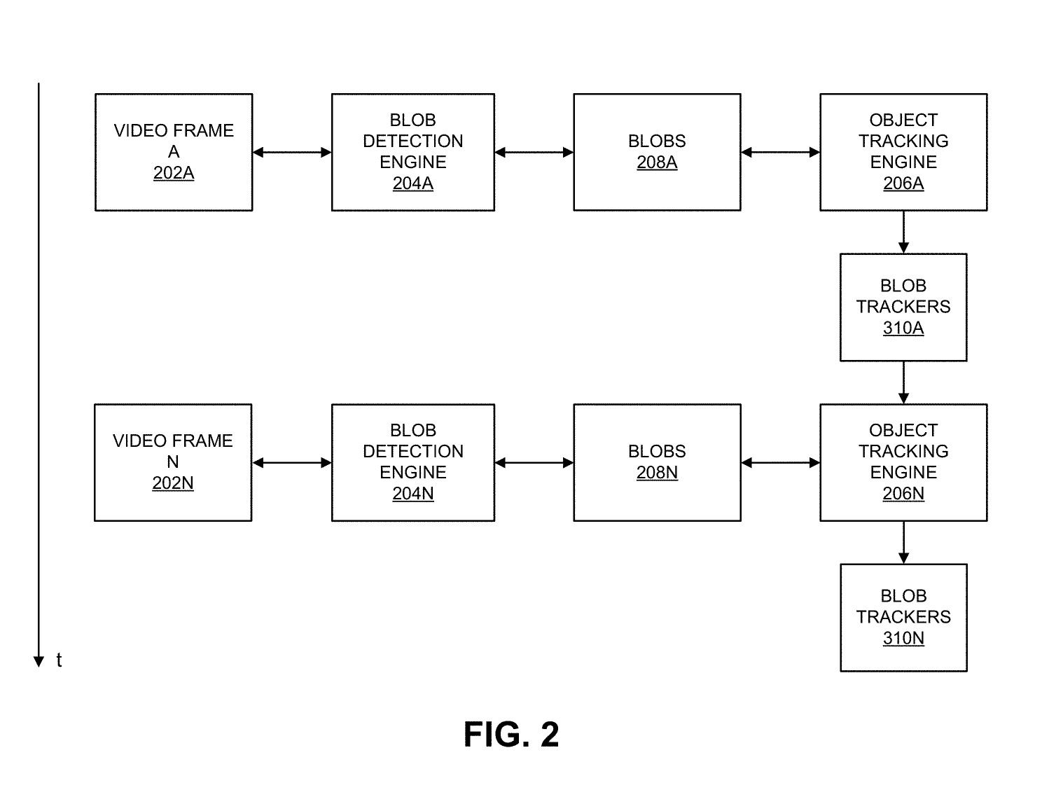

FIG. 2 is an example of the video analytics system (e.g., video analytics system 100) processing video frames across time t. As shown in FIG. 2, a video frame A 202A is received by a blob detection engine 204A. The blob detection engine 204A generates foreground blobs 208A for the current frame A 202A. After blob detection is performed, the foreground blobs 208A can be used for temporal tracking by the object tracking engine 206A. Costs (e.g., a cost including a distance, a weighted distance, or other cost) between blob trackers and blobs can be calculated by the object tracking engine 206A. The object tracking engine 206A can perform data association to associate or match the blob trackers (e.g., blob trackers generated or updated based on a previous frame or newly generated blob trackers) and blobs 208A using the calculated costs (e.g., using a cost matrix or other suitable association technique). The blob trackers can be updated, including in terms of positions of the trackers, according to the data association to generate updated blob trackers 310A. For example, a blob tracker's state and location for the video frame A 202A can be calculated and updated. The blob trackers location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection engine 204N generates foreground blobs 208N for the frame N 202N. The object tracking engine 206N can then perform temporal tracking of the blobs 208N. For example, the object tracking engine 206N obtains the blob trackers 310A that were updated based on the prior video frame A 202A. The object tracking engine 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection engine 104. Blob detection is used to segment moving objects from the global background in a scene. The blob detection engine 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purpose. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (GMM). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

$$P ( {X}_{t} ) = {\sum }_{i = 1}^{K} {ω}_{i , t} N ( {X}_{t} \vert {μ}_{i , t} , {\sum }_{i , t} ) \qquad Equation ( 1 )$$

An equation of the GMM model is shown in equation (1), wherein there are K Gaussian models. Each Guassian model has a distribution with a mean of μ and variance of Σ, and has a weight ω. Here, i is the index to the Gaussian model and t is the time instance. As shown by the equation, the parameters of the GMM change over time after one frame (at time t) is processed.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask generated from background subtraction, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel, which is currently being processed. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with a 3×3 window size is called first, and three function calls of dilation of the 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. One example of the connected component analysis performed by the connected component analysis engine 316 is implemented as follows:

for each pixel of the foreground mask {
if it is a foreground pixel and has not been processed, the following steps apply:
   Apply FloodFill function to connect this pixel to other foreground and generate a connected component
   Insert the connected component in a list of connected component.
   Mark the pixels in the connected component as being processed.}

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or −1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection engine 104. In some examples, the blob processing engine 318 can perform content-based filtering of certain blobs. For instance, a machine learning method can determine that a current blob contains noise (e.g., foliage in a scene). Using the machine learning information, the blob processing engine 318 can determine the current blob is a noisy blob and can remove it from the resulting blobs that are provided to the object tracking engine 106. In some examples, the blob processing engine 318 can merge close blobs into one big blob to remove the risk of having too many small blobs that could belong to one object. In some examples, the blob processing engine 318 can filter out one or more small blobs that are below a certain size threshold (e.g., an area of a bounding box surrounding a blob is below an area threshold). In some embodiments, the blob detection engine 104 does not include the blob processing engine 318, or does not use the blob processing engine 318 in some instances. For example, the blobs generated by the connected component analysis engine 316, without further processing, can be input to the object tracking engine 106 to perform blob and/or object tracking.

FIG. 4 is a block diagram illustrating an example of an object tracking engine 106. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking engine 106 can obtain the blobs 408 of a current video frame from the blob detection engine 104. The cost determination engine 412 can also obtain the blob trackers 410A updated from the previous video frame (e.g., video frame A 202A). A cost function can then be used to calculate costs between the object trackers 410A and the blobs 408. Any suitable cost function can be used to calculate the costs. In some examples, the cost determination engine 412 can measure the cost between a blob tracker and a blob by calculating the Euclidean distance between the centroid of the tracker (e.g., the bounding box for the tracker) and the centroid of the bounding box of the foreground blob. In one illustrative example using a 2-D video sequence, this type of cost function is calculated as below:

Cost_{tb}=\sqrt{(tₓ−bₓ)²+(t_{y}−b_{y})²}

The terms (tₓ, t_{y}) and (bₓ, b_{y}) are the center locations of the blob tracker and blob bounding boxes, respectively. As noted herein, in some examples, the bounding box of the blob tracker can be the bounding box of a blob associated with the blob tracker in a previous frame. In some examples, other cost function approaches can be performed that use a minimum distance in an x-direction or y-direction to calculate the cost. Such techniques can be good for certain controlled scenarios, such as well-aligned lane conveying. In some examples, a cost function can be based on a distance of a blob tracker and a blob, where instead of using the center position of the bounding boxes of blob and tracker to calculate distance, the boundaries of the bounding boxes are considered so that a negative distance is introduced when two bounding boxes are overlapped geometrically. In addition, the value of such a distance is further adjusted according to the size ratio of the two associated bounding boxes. For example, a cost can be weighted based on a ratio between the area of the blob tracker bounding box and the area of the blob bounding box (e.g., by multiplying the determined distance by the ratio).

In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, may be based on the determined costs. The data association engine 414 matches or assigns a tracker with a corresponding blob and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

In addition to the Hungarian method, other robust methods can be used to perform data association between blobs and blob trackers. For example, the association problem can be solved with additional constraints to make the solution more robust to noise while matching as many trackers and blobs as possible.

Regardless of the association technique that is used, the data association engine 414 can rely on the distance between the blobs and trackers. The location of the foreground blobs are identified with the blob detection engine 104. However, a blob tracker location in a current frame may need to be predicated from a previous frame (e.g., using a location of a blob associated with the blob tracker in the previous frame). The calculated distance between the identified blobs and estimated trackers is used for data association. After the data association for the current frame, the tracker location in the current frame can be identified with its associated blob's (or blobs′) location in the current frame. The tracker's location can be further used to update the tracker's motion model and predict its location in the next frame.

Once the association between the blob trackers 410A and blobs 408 has been completed, the blob tracker update engine 416 can use the information of the associated blobs, as well as the trackers' temporal statuses, to update the states of the trackers 410A for the current frame. Upon updating the trackers 410A, the blob tracker update engine 416 can perform object tracking using the updated trackers 410N, and can also provide the update trackers 410N for use for a next frame.

The state of a blob tracker can includes the tracker's identified location (or actual location) in a current frame and its predicted location in the next frame. The state can also, or alternatively, include a tracker's temporal status. The temporal status can include whether the tracker is a new tracker that was not present before the current frame, whether the tracker has been alive for certain frames, or other suitable temporal status. Other states can include, additionally or alternatively, whether the tracker is considered as lost when it does not associate with any foreground blob in the current frame, whether the tracker is considered as a dead tracker if it fails to associate with any blobs for a certain number of consecutive frames (e.g., 2 or more), or other suitable tracker states.

Other than the location of a tracker, there may be other status information needed for updating the tracker, which may require a state machine for object tracking. Given the information of the associated blob(s) and the tracker's own status history table, the status also needs to be updated. The state machine collects all the necessary information and updates the status accordingly. Various statuses can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other objects of interest) intersect, the two trackers associated with the two objects will be merged together for certain frames, and the merge or occlusion status needs to be recorded for high level video analytics.

One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified at its predicted location from the previous frame, meaning that the motion model for the blob tracker is not corrected and the prediction propagates with the blob tracker's last model (from the previous frame).

Regardless of the tracking method being used, a new tracker starts to be associated with a blob in one frame and, moving forward, the new tracker may be connected with possibly moving blobs across multiple frames. When a tracker has been continuously associated with blobs and a duration has passed, the tracker may be promoted to be a normal tracker and output as an identified tracker-blob pair. A tracker-blob pair is output at the system level as an event (e.g., presented as a tracked object on a display, output as an alert, or other suitable event) when the tracker is promoted to be a normal tracker. A tracker that is not promoted as a normal tracker can be removed (or killed), after which the track can be considered as dead.

As discussed above, foreground pixels can be grouped into blobs after connected component analysis. Sometimes, however, one object may be detected as multiple blobs. Because these multiple blobs are, in reality, only one object, the multiple blobs should not be tracked individually, and should instead be tracked as one blob. Sometimes, “noise” in the frame may also be detected as blobs. For example, leaves blowing across an outdoor scene may be detected, and a video content analysis may attempt to track them as blobs. Such blobs should be, ideally, filtered out. Small blobs, however, that are in actuality part of larger objects, should not be filtered out, and doing so may lead to inaccurate tracking of the overall object. It may also occur in a scene that distinct objects are relatively close to one another, and are detected as separate blobs. Because the blobs represent different objects, the blobs should not be merged, even though they are close together.

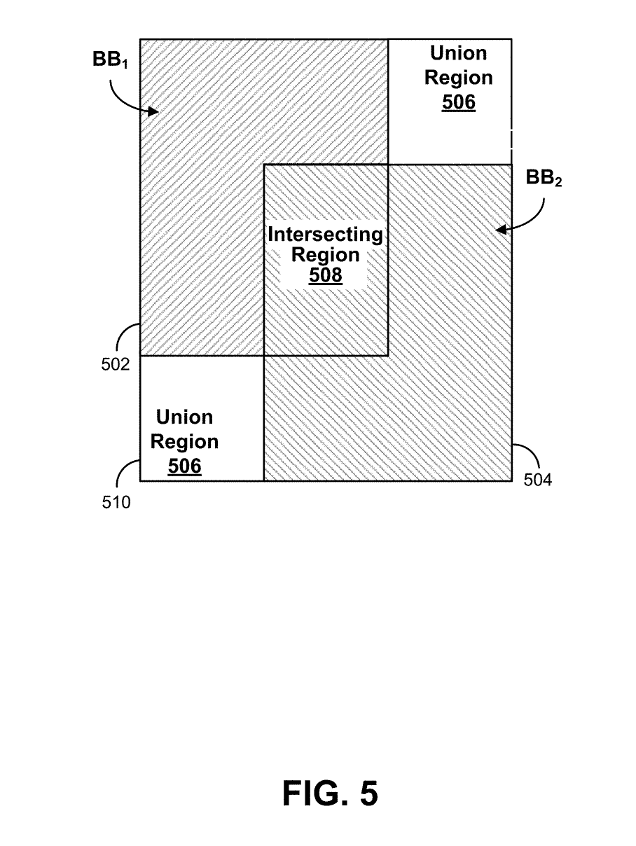

The occurrence of multiple blobs that include the pixels for only one object is handled through blob merging processes. Blob merging generally requires deciding whether any two blobs should be merged, and if so, applying blob merging for the two blobs to obtain a unified blob. An example of a simple blob merge case is illustrated in FIG. 5. As discussed above, a blob can be represented by a bounding box. The example of FIG. 5 illustrates two overlapping bounding boxes, BB₁ 502 and BB₂ 504. The intersection of BB₁ 502 and BB₂ 504, BB₁∩BB₂, is illustrated as the intersecting region 508. The union of BB_{A} 502 and BB_{B} 504, BB₁∪BB₂ can be used to define a merged bounding box 510. The union of BB_{A} 502 and BB_{B} 504 includes non-intersecting regions, labeled in FIG. 5 as union regions 506.

In one example, the union of BB_{A} 502 and BB_{B} 504 can be defined using the far corners of BB_{A} 502 and BB_{B} 504 to define a new bounding box. Specifically, each bounding box can be represented by the set of values (x, y, w, h), where (x, y) represent the upper-leftmost point of a bounding box, w is the width of the bounding box, and h is the height of the bounding box. The union of BB_{A} 502 and BB_{B} 504 can thus be represented by the following equation:

BB₁∪BB₂=(min(x₁,x₂),min(y₁,y₂),max(x₁+w₁−1,x₂+w₂−1)−min(x₁,x₂),max(y₁+h₁−1,y₂+h₂−1)−min(y₁,y₂))

The resulting merged bounding box 510, illustrated in FIG. 5, includes both the area covered by BB_{A} 502 and the area covered BB_{B} 504, as well as the union regions 506 that are outside of both bounding boxes.

In one example merge process, the process may evaluate an overlap ratio to determine whether two bounding boxes should be merged. The overlap ratio can be defined as the total area occupied by both bounding boxes, less the intersecting region 508, versus the area occupied by the merged bounding box 510. Mathematically, the overlap ration can be expressed using the following equation:

$$\frac{{BB}_{1} + {BB}_{2} - {BB}_{1} ⋂ {BB}_{2}}{{BB}_{1} ⋃ {BB}_{2}}$$

In this example, when the overlap ratio is greater than a threshold value (e.g. 0.7, 0.5, 0.3 or some other value), the merge process will merge the two bounding boxes.

A scene may include multiple blobs, and sometimes more than two blobs may need to be merged into one blob. A merge process thus may iteratively examine all the blobs in a frame until the process determines that no more blobs should be merged. An example process can be provided with a list that includes the blobs found in a frame. The example process can then examine the blobs in a frame to identify blobs that should be merged. An example procedure for such a process is as follows:

while (1)
Length = List.length
for each blob i in List

for each blob j > i in List

BB1 = List[i]
BB2 = List[j]
if (Blob_Merge_Decision(BB1, BB2))

Insert_Into_List(Union(BB1, BB2))
Erase_From_List(BB1, BB2)
break

if (length == List.length)

break

In the above example process, the length of the blob list is determined, where “List” is a list that includes the blobs determined for a video frame. Then, each entry in the list is checked against every other entry in the list to determine whether any two blobs should be merged. That is, the process checks whether each blob BB1 (from list index i) should be merged with blob BB2 (from list index j), where j is greater than i, and j is less than the length of the list. Should the process determine that BB1 and BB2 should be merged, both BB1 and BB2 removed for the list, and the union of BB1 and BB2 (that is, a bounding box that results from merge BB1 and BB2) is inserted into the list. BB1 and BB2 are removed from the list because, once merged, BB1 and BB2 no longer exist as distinct bounding boxes. The union of BB1 and BB2 are added to the list so that the merged bounding box for BB1 and BB2 can be considered on the next iteration of the process. The process terminates when the length of the list is unchanged after every blob in the list is checked against every other blob in the list, and the length of the list has not changed. The length of the list not changing indicates that no merge happened, which indicates that no further bounding boxes will be merged.

A simple merging process, such as described in the above with respect to FIG. 5, may be too simple for handling all cases where blobs may need to be merged. For example, processes such as the one described above compare an overlap ratio between two bounding boxes against a fixed threshold to determine whether the bounding boxes should be merged. Using a fixed threshold, however, may be insufficiently robust. A large threshold may cause too many merges to be rejected while a small threshold may cause merges to happen too often.

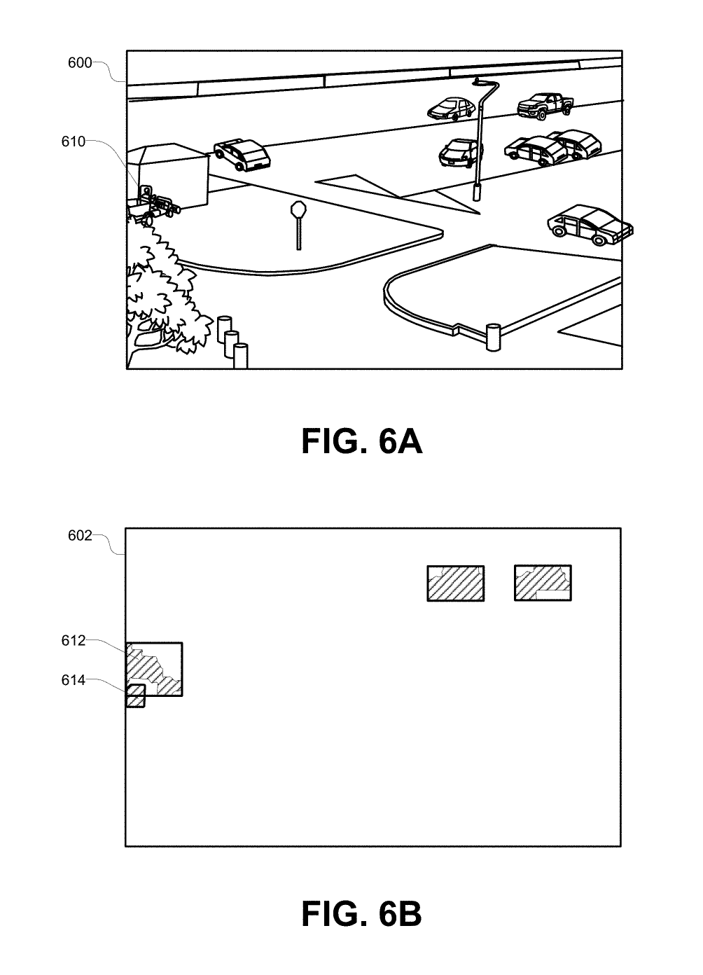

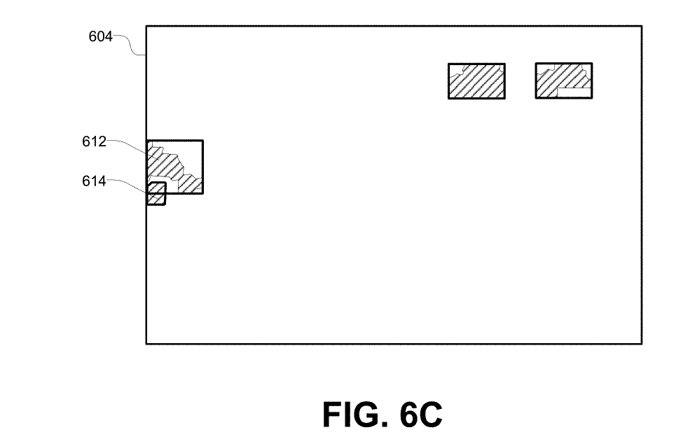

FIG. 6A-FIG. 6C illustrate an example where a fixed threshold that was too small caused blobs that should have been merged to not be merged. FIG. 6A illustrates an example of a video frame 600 where a video content analysis system has detected several moving objects. The scene features a parking lot that includes several grassy areas. A lawnmower 610 is moving in the left-hand grassy area, and the lawnmower 615 happens to be nearly the same color as the grass (green).

FIG. 6B illustrates an example a video frame 602 that includes only the blobs that the video content analysis system extracted from the video frame 600 illustrated in FIG. 6A. The video frame 602 of FIG. 6B also includes bounding boxes for each of the blobs. As illustrated in this example, the system has identified the lawnmower 610 on the left side of the frame 602 as two blobs 612, 614, rather than one. This may have occurred because the lawnmower 610 is nearly the same color as the background lawn, a challenging situation in which to extract the correct foreground pixels. The lawnmower 610 was thus identified as one large blob 612 and one small blob 614. The two blobs 612, 614, however, do overlap.

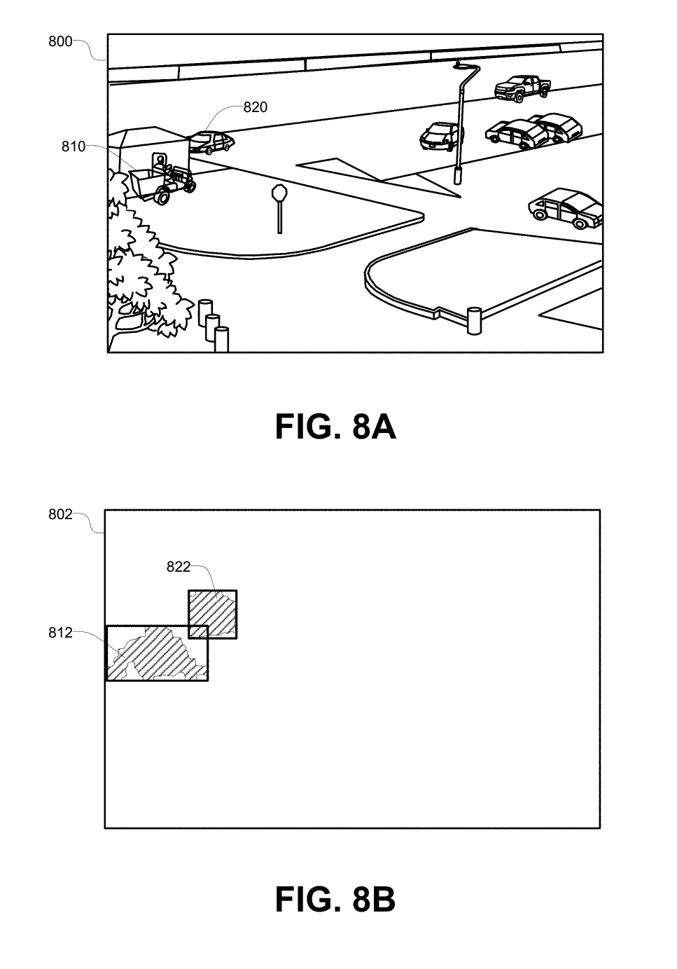

FIG. 6C illustrates an example of a video frame 604 that includes the blobs extracted from the video frame 600 of FIG. 6A and the bounding boxes that may remain after a merge process that uses a fixed threshold is applied. In the example of FIG. 6C, even though the two blobs 612, 614 that are associated with the lawnmower 610 overlap, the merge process failed to merge the two blobs 612, 614. The merge process may have determined that the overlap ratio was too great. A larger threshold value may have resulting in the bounding boxes being merged, but, as discussed in the example provided by FIGS. 8A-8C, a larger threshold may also cause bounding boxes to be merged that should not be merged.

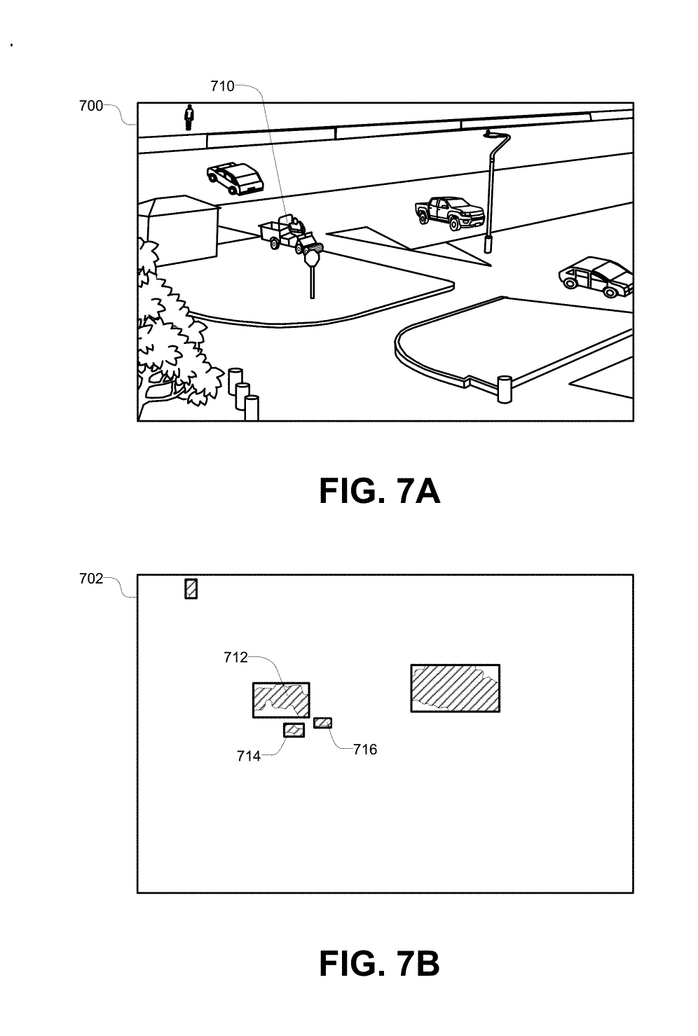

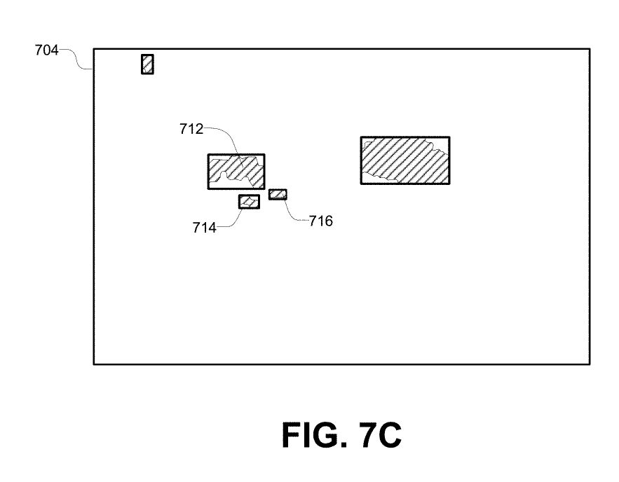

Another problem that may be encountered by merge processes that use a fixed threshold occurs when the threshold fails to account for related blobs that do not overlap. FIG. 7A-FIG. 7C illustrate an example where an object is detected as multiple, non-overlapping blobs. FIG. 7A illustrates an example of a video frame 700 where several blobs have been identified. The scene features a parking lot and grassy areas, where a green lawnmower 710 is positioned on the grass. Though identifiable to the human eye, the color of the lawnmower 710 is close the color of the grass.

FIG. 7B illustrates an example of a video frame 702 that includes only the blobs that were identified for each of the moving objects in the video frame 700 illustrated in FIG. 7A. FIG. 7B also illustrates the bounding boxes for each of the blobs. In the example frame 702, the video content analysis system has identified the lawnmower 710 as one large blob 712 and two very small blobs 714, 716. Furthermore, the small blobs 714, 716 do not overlap with the large blob 712.

FIG. 7C illustrates an example of a video frame 704 that includes the blobs determined for the video frame 700 of FIG. 7A and the bounding boxes that may result after a merge processes that uses a fixed threshold is applied. In the example of FIG. 7C, the merge process has not merged the blobs 712, 714, 716 for the lawnmower 710, because the blobs 712, 714, 716 do not overlap. In this example, no value for the overlap threshold would have resulted in the blobs 712, 714, 716 being merged. As a result, parts of the lawnmower 710 may be tracked separately, or, because two of the blobs 714, 716 are so small, parts of the lawnmower 710 may not be tracked at all. In either case, the tracking information for the scene may become inaccurate.

FIG. 8A-FIG. 8C illustrates an example of a video frame 800 where relying only on a fixed threshold resulted in two blobs 812, 822 that are unrelated being merged. FIG. 8A illustrates an example of a video frame 800 featuring a parking lot and several grassy areas. A green lawnmower 810 is positioned on the grass, and a car 820 is moving nearby.

FIG. 8B illustrates an example of a video frame 802 that includes only the blobs that may be identified for the video frame 800 in FIG. 8A. The video frame 802 of FIG. 8B also includes the bounding boxes for the identified blobs. As in the example video frame 802, the lawnmower 810 has been identified as one large blob 812, and the nearby car 820 has also been identified as one large blob 822. Due to the geometries of the two blobs 812, 822, the bounding boxes for the two blobs 812, 822 overlap slightly.

FIG. 8C illustrates an example of a video frame 804 that includes the blobs determined for the video frame 800 of FIG. 8A and the bounding box that may remain after a merge process has examined the bounding boxes illustrated in FIG. 8B. In the example of FIG. 8C, the merge process may have determined that the overlap between the bounding boxes for the lawnmower blob 812 and the car blob 822 was sufficiently for the bounding boxes to be merged. As a result, in this video frame 804, the lawnmower 810 and the car 820 are represented by one, merged bounding box 830 Setting the overlap threshold to a lower value may have prevented these blobs 812, 822 from being merged, but then cases such as is illustrated in FIG. 6A-FIG. 6C may not be correctly resolved. In the example of FIG. 8C, consideration of the size of the two blobs 812, 822—both of which are relatively large—may have prevented the two blobs 812, 822 from having been merged.

In various implementations, a content-adaptive bounding box merge engine may more accurately merge, or not merge, the blobs illustrated in the above examples. A content-adaptive merge engine may use an adaptive distance threshold, which can be adapted according to the sizes of the bounding boxes being considered for merging. A content-adaptive merge engine can also consider not only the spatial relationship between two bounding boxes, but also the sizes of the bounding boxes. The content-adaptive merge engine can also consider the size of a merged bounding box that may result should two blobs be merged.

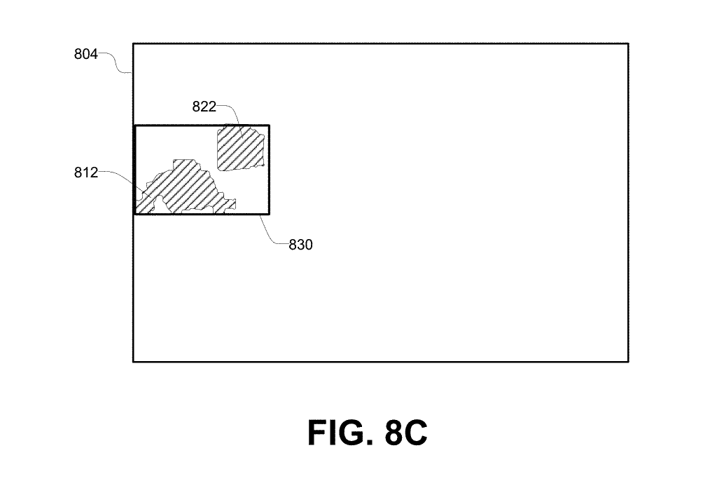

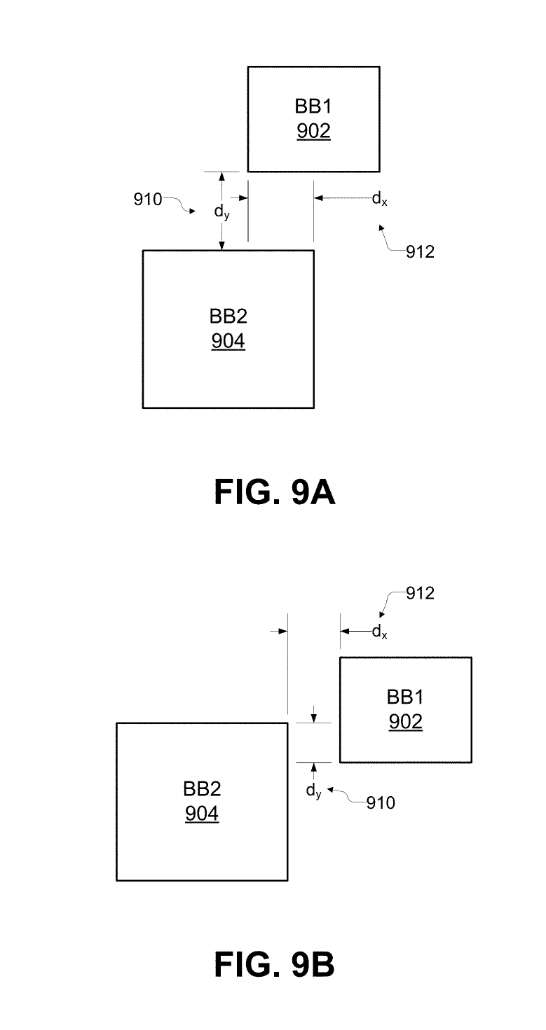

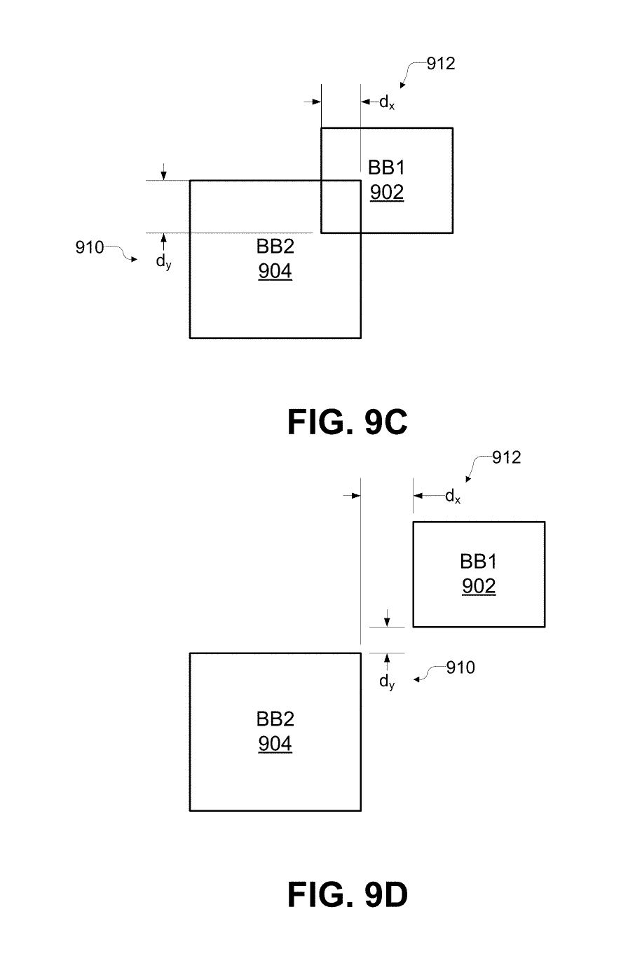

As discussed above, in some cases an object may be identified as two or more blobs, where the bounding boxes for those blobs do not have an intersecting region. In other cases, two blobs may have an intersecting region, or may simply be close to each other, but in fact represent two different objects. FIG. 9A-FIG. 9D illustrate examples of various spatial relationships between which two bounding boxes. In FIG. 9A, a first bounding box, BB1 902, and a second bounding box, BB2 904, do not have an intersecting region, and are some distance apart. The distances are generally measured from the nearest point between the bounding boxes. Specifically, BB1 902 and BB2 904 are a distance d_{y} 910 apart in the vertical direction, meaning that, in this example, the bottom edge of BB1 902 is d_{y} 910 pixels (or picas or points or millimeters, or some other unit of measure) above the top edge of BB2 904. BB1 902 and BB2 904, however, overlap in the horizontal direction. That is, the horizontal coordinate of the left edge of BB1 902 falls within the horizontal space occupied by BB2 904. The horizontal distance, dₓ 912, between BB1 902 and BB2 904, measured in this example by subtracting the right edge of BB2 904 from the left edge of BB1 902, is thus less than zero.

In FIG. 9B, BB1 902 and BB2 904 also do not have an intersecting region. In this example, BB1 902 is a distance dₓ 912 away from BB2 904 in the horizontal direction, and overlaps with BB2 904 in the vertical direction. Thus the vertical distance, d_{y} 910, between BB1 902 and BB2 904 is less than zero.

In FIG. 9C, BB1 902 and BB2 904 have an intersecting region. In this example, both the vertical and horizontal distances, d_{y} 910 and dₓ 912, respectively, are less than zero.

In FIG. 9D, BB1 902 and BB2 904 do not overlap in either the vertical or horizontal directions. Thus, d_{y} 910 and dₓ 912 are both a value greater than zero.

In various implementations a content-adaptive bounding box merge engine may consider the distance between the bounding boxes to determine whether the bounding boxes should be merged. Specifically, the engine may separately consider the horizontal distance and the vertical distance between the bounding boxes. Additionally, when the bounding boxes overlap in a particular direction, the distance can be considered to be zero.

For example, in FIG. 9A, BB1 902 and BB2 904 overlap in the horizontal direction, thus dₓ 912 can be treated as equal to zero. BB1 902 and BB2, however, do not overlap in the vertical direction, thus the bounding box merge engine will consider d_{y} 910 when determining whether to merge the bounding boxes. As another example, in FIG. 9B, BB1 902 overlaps with BB2 904 in the vertical direction, thus d_{y} 910 will be considered zero. In this example, the bounding boxes do not overlap in the horizontal direction, thus the content-adaptive merge engine will consider dₓ 912 when determining whether to merge the bounding boxes. As another example, in FIG. 9D, BB1 902 and BB2 904 do not overlap in either the horizontal or the vertical directions, thus the engine will consider both d_{y} 910 and dₓ 912. In the example of FIG. 9C, the bounding boxes overlap in both the horizontal and vertical directions. In this example, the merge engine may consider aspects other than the distance between the bounding boxes, such as the overlap ratio and/or the size of a bounding box that would result from merging the bounding boxes.

In various implementations, the content-adaptive bounding box merge engine may further use a two-dimensional distance threshold when considering the distance between two bounding boxes. For example, the engine can define a horizontal threshold and a vertical threshold, [DT_{X}, DT_{Y}]. In various implementations, either the horizontal or the vertical (or both) distance thresholds can be set to a fixed value. For example, in some scenes, it may be expected (for example, from observation and/or measurement) that blobs that are outside of a certain distance should not be merged.

In various implementations, the content-adaptive bounding box merge engine may use content-adaptive distance thresholds. “Content-adaptive” in this case means that the engine can adapt the distance thresholds to the sizes of the bounding boxes being considered. For example, for a given scene, particular types of objects (e.g., cars or people or both) may be prevalent. In such examples, it can be assumed that, for example, an object smaller than a person that is closely located to the person is likely part of the person. In this example, a merge should occur. In contrast, an object as large as, for example, a car-sized object that is located near another object that is as large as a car is likely a distinct object, rather than being part of the other object. In this example, a merge should not occur. Using content-adaptive thresholds may improve the probability that small blobs will be merged (with other small blobs or with large blobs), and decrease the probability that a large blob will be merged with another large blob.

In various implementations, the content-adaptive bounding box merge engine may quantize the size of a blob by the pixel (or points or picas or some other unit of measure) area of the blob or the blob's bounding box. Using such a method, a large blob can include a larger pixel area than a small blob. In some cases, however, blob size quantization may be more robust when the size of a blob is compared with a minimum object size. For example, when a blob is larger than the minimum object size, the blob should be considered large, while a blob that is smaller than the minimum object size should be considered small. Generally, the minimum object size is based on or is estimated from what could be considered a reasonable size for the smallest objects in a scene. The minimum object size may thus also be referred to as the minimum reasonable object size. In various implementations, the minimum object size can be configured or calculated for a particular scene. In various implementations, a video content analysis system can learn the minimum object size from observing a scene. For example, the system can keep track of the sizes of bounding boxes detected across multiple frames. Using these historical bounding box sizes, the system can, for example, determine a median, a mean, a maximum, and/or a minimum bounding box size, and use one of these values (or some value based on these values) as the minimum object size. The system can further adjust the minimum object size as the system learns more about the scene over time.

In various implementations, the content-adaptive bounding box merge engine can be configured for a particular scene being observed by a surveillance camera. For example, the camera may be placed indoors or outdoors, and/or be subjected to fixed or changing lighting conditions, where the changes may be abrupt or gradual. Furthermore, a camera may record types of objects in different scenes (e.g., people versus automobiles). In various implementations, a content-adaptive bounding box merge engine may use a combination of fixed-distance merge techniques and adaptive merge techniques. In various implementations, the engine may choose one technique over another as more appropriate for a given scene.

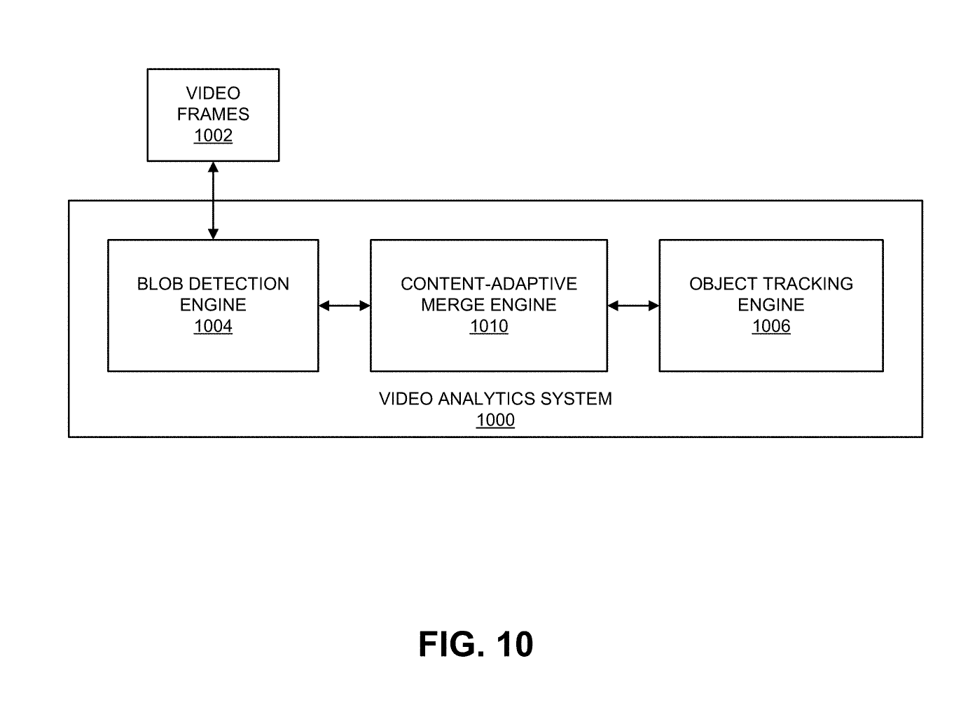

FIG. 10 illustrates an example of a video analytics system 1000 that includes a content-adaptive merge engine 1010. The video analytics system 1000 can be part of a system that includes a video capture device, such as for example an IP camera. In various implementations, the IP camera can be used to capture video frames 1002, which can be provided to the video analytics system 1000 for analysis. The video frames 1002 can be part of one or more video sequences.

In various implementations, the video analytics system 1000 can include a blob detection engine 1004. The blob detection engine 1004 can detect one or more blobs in the video frames 1002. The blob detection engine 1004 can include, for example a background subtraction engine, a morphology engine, a connected component analysis engine, and a blob processing engine. The output of the blob-detection engine 1004 is one or more blobs determined for a video frame 1002.

In various implementations, the video analytics system 1000 can also include a content-adaptive merge engine 1010. In some cases, one object in a video frame may be identified by the blob detection engine 1004 as two or more blobs. For example, part of an object may blend in with the background, such that part of the object is identified as background pixels and the remaining parts of the object appear as disconnected objects. As another example, part of an object may be relatively stationary, while another part moves more actively, such that the stationary part may be identified as background pixels. As discussed further below, the content-adaptive merge engine 1010 determines, based on various criteria, whether blobs identified by the blob detection engine 1004 should be merged. The content-adaptive merge engine 1010 outputs blobs, including both merged blobs and blobs that were not merged because these blobs did not meet the merging criteria(s).

In various implementations, the video analytics system 1000 can also include an object tracking engine 1006. The object tracking engine 1006 can track the one or more blobs across the frames 1002 of the video sequence. The object tracking engine 1006 can receive blobs from the content-adaptive merge engine 1010, and can associate a blob tracker with each blob. Blob trackers maintain historical information about each blob. In various implementations, the object tracking engine 1006 can include a cost determination engine, a data association engine, and a blob tracker update engine. The object tracking engine 1006 output blob trackers that have been updated for a current video frame 1002.

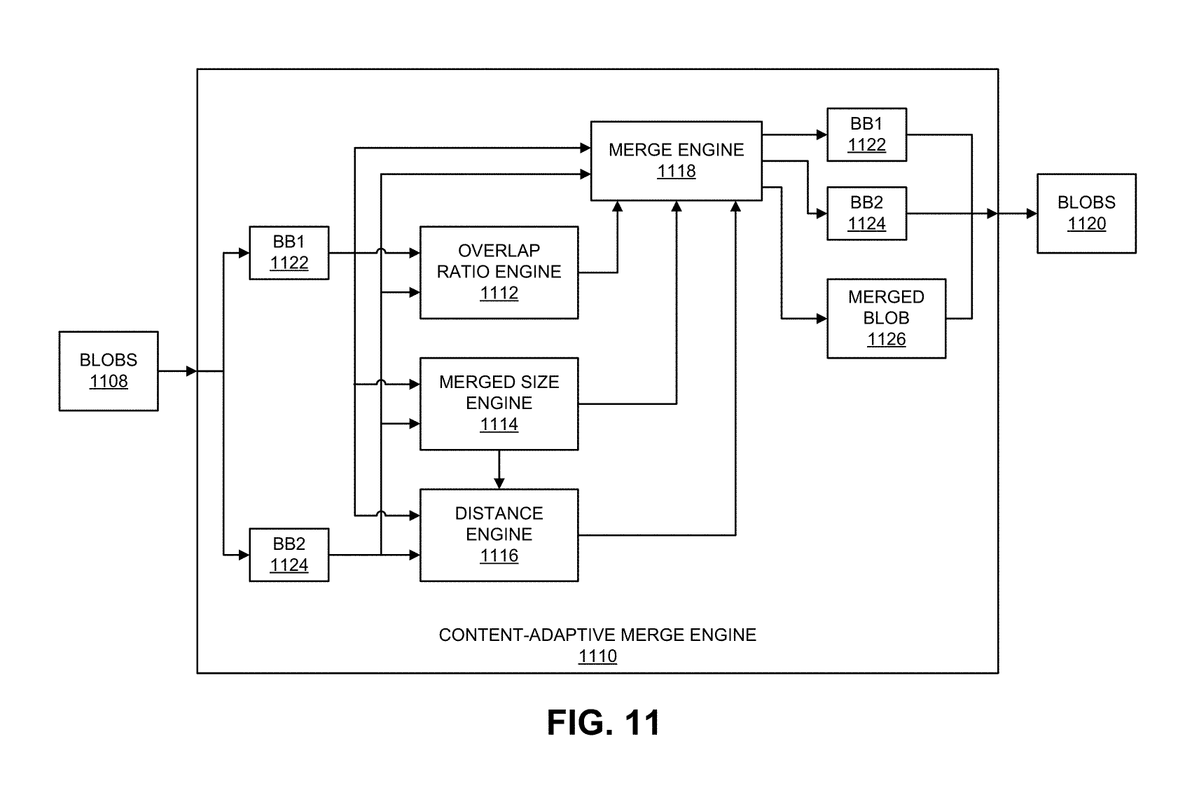

FIG. 11 illustrates an example of a content-adaptive merge engine 1110. The content-adaptive merge engine 1110 can receive a list of blobs 1108 determined for an input video frame. Each blob in the list of blobs 1108 can include a bounding box that can provide information such as an approximate size, shape, and location of the blob. The list of blobs 1108 can include only one blob, in which case the content-adaptive merge engine 1110 can be bypassed. When the list of blobs 1108 includes more than one blob, the content-adaptive merge engine 1110 can examine two blobs—BB1 1122 and BB2 1124 in the illustrated example—from the list of blobs 1108 at a time, and determine whether the two blobs 1122, 1124 should be merged.

In various implementations, the input blobs 1122, 1124 can be provided to various engines, which each consider whether the input blobs 1122, 1124 should be merged. For example, the content-adaptive merge engine 1110 can include an overlap ratio engine 1112, a merged size engine 1114, and a distance engine 1116. Each of the overlap ratio engine 1112, the merged size engine 1114, and the distance engine 1116 can consider different criteria for whether the input blobs 1112, 1124 should be merged, and can each produce a merge determination. In the example of FIG. 11, the overlap ratio engine 1112, the merged size engine 1114, and the distance engine 1116 are illustrated as operating in parallel, and producing individual merge determinations. In various implementations, the various engines 1112, 1114, 1116 can operate in parallel, as illustrated. In various implementations, the engines 1112, 1114, 1116 can alternatively operate serially. For example, in these implementations, the merge determination from the overlap ratio engine 1112 can be provided (along with the input blobs 1122, 1124) to the merged size engine, and the merge determination of the merged size engine 1114 can be provided (along with the input blobs 1122 1124) to the distance engine 1116. In this example, the distance engine 1116 can produce a final merge determination. In various implementations, the engines 1112, 1114, 1116 can operate serially in some other order.

The overlap ratio engine 1112 can consider the overlap between the input BB1 1122, and BB2 1124. For example, when BB1 1122, and BB2 1124 overlap, BB1 1122 and BB2 can include an intersecting region and a non-intersecting region. The intersecting region is the area where BB1 1122 and BB2 1124 overlap, and the non-intersecting region is the area that includes the pixels of BB1 1122 and BB2 1124 that is outside the intersecting region. The overlap ratio engine 1112 can consider the ratio between the non-intersecting region and the intersecting region. When the ratio is greater than an overlap threshold (e.g, 0.5, 0.7, 0.9 or some other value), the overlap ratio engine 1112 may output that the blobs 1122, 1124 should be merged. When the ratio is less than the overlap threshold, the overlap ratio engine 1112 may output that the blobs 1122, 1124 should not be merged. In some implementations, the overlap threshold is a fixed value. In some implementations, the overlap threshold is configured or adapted to the sizes of the objects typically found in a scene. For example, the threshold may be configured or adapted to assume that most objects in a scene are people or cars or some other object.

The merged size engine 1114 can consider the size blob or bounding box that would result should BB1 1122 and BB2 1124 be merged, as well as whether the merging of BB1 1122 and BB2 1124 would result in an object that is larger than a size threshold. For example, the merged size engine 1114 can determine a candidate merged bounding box. The candidate merged bounding box is the bounding box that treats BB1 1122 and BB2 1124 as one blob. The merged size engine 1114 can compute the size of the candidate merged bounding box, and compare this size to the size threshold. Alternatively or additionally, the merged size engine 1114 can compute the size of a blob that includes both BB1 1122 and BB2 1124 by adding the areas of BB1 1122 and BB2 1124. The merged size engine 1114 can compare this size to size threshold. When the size of the merged blob or bounding box is less than the size threshold, the merged size engine 1114 may output that the blobs 1122, 1124 should be merged. Otherwise, the merged size engine 1114 may output that the blobs 1122, 1124 should not be merged.

In various implementations, the size threshold used by the merged size engine 1114 can content-adaptive. For example, the size threshold can be based on a minimum reasonable object size for objects in the scene. The minimum reasonable object size is the size of the smallest object that can typically be found in a scene. For example, in a street scene, the size of a dog can be the minimum reasonable object size, but the size of a person's hand or the size of a blowing leaf are smaller than the minimum reasonable object size. In various implementations, the size threshold can be set to the minimum reasonable object size, two times the minimum reasonable object size, four times the minimum reasonable object size, or some other multiple of the minimum reasonable object size. In various implementations, the size threshold can be configured for a particular scene. For example, the size threshold can be set to the size of a person located a particular distance from the camera. In various implementations, the size threshold can be adjusted over time. For example, the size threshold can be adjusted up or down as historical object sizes are determined over the course of multiple frames.

The distance engine 1116 can consider the distances between BB1 1122 and BB2 1124, and determine whether BB1 1122 and BB2 1124 based on the distances being less than respective thresholds. For example, the distance engine 1116 can determine a horizontal distance between BB1 1122 and BB2 1124. When BB1 1122 and BB2 1124 do not overlap in the horizontal direction, the horizontal distance is the horizontal distance between BB1 1122 and BB2 1124. When BB1 1122 and BB2 1124 overlap in the horizontal direction, the horizontal distance is the amount by which BB1 1122 and BB2 1124 overlap in the horizontal direction. The overlap distance is a negative value. In some cases, the horizontal distance between BB1 1122 and BB2 1124 can be zero. Similarly, the distance engine 1116 can determine a vertical distance between BB1 1122 and BB2 1124. The vertical distance is the distance between BB1 1122 and BB2 1124 when BB1 1122 and BB2 1124 do not overlap in the vertical direction, and is the overlap distance when BB1 1122 and BB2 1124 overlap in the vertical direction (a negative value). In some cases the vertical distance is zero. In some implementations, when the horizontal or vertical distance is less than zero, the horizontal or vertical distance that is less than zero is treated as zero.

The distance engine 1116 can further compare the horizontal distance to a horizontal distance threshold. The distance engine 1116 can also compare the vertical distance to a vertical distance threshold. When both the horizontal distance and the vertical distance are less than or equal to the horizontal and vertical thresholds, respectively, the distance engine 1116 may output that the blobs 1122, 1124 should be merged. Otherwise, the distance engine 1116 may output that the blobs 1122, 1124 should not be merged.

In various implementations, the horizontal and/or vertical thresholds may be content adaptive. For example, the horizontal and/or vertical distance thresholds can be set to an initial constant value. In various implementations, the constant value can be configured for the particular objects that can be found in a scene. For example, for indoor scenes, where objects may be closer to the camera, the constant value can be set to a larger value. In various implementations, the horizontal and/or vertical thresholds can be updated based on the size of the blob that would result should BB1 1122 and BB2 1124 be merged. For example, the distance engine 1116 can receive a size determined by the merged size engine 1114, where the size is the size of the bounding box or blob that would result should BB1 1122 and BB2 1124 be merged. In these implementations, the horizontal (or vertical) distance threshold can be set to zero when the blobs 1122, 1124 do not overlap in horizontal (or vertical) direction, can be set to the constant value when the size of the merged bounding box is less than a multiple of the minimum object size, or can otherwise be set to a fraction of the constant value. Alternatively or additionally, the horizontal (or vertical) distance threshold can be set to the minimum value from among a previous value of the horizontal (or vertical) distance threshold and the widths (or heights) of the input blobs 1122, 1124.

The merge determinations from each of the overlap ratio engine 1112, the merge size engine 1114, and the distance engine 1116 can be provided to a merge engine 1118. The merge engine 1118 can also receive as inputs the input blobs 1122, 1124. The merge engine 1118 can consider each of the merge determinations and determine whether BB1 1122 and BB2 1124 should be merged. In some implementations, when at least one of the engines 1112, 1114, 1116 determined that the input blobs 1122, 1124 should be merged, the merge engine 1118 will merge the input blobs 1122, 1124. In some implementations, each merge determination can be assigned a priority or weight. For example, when the overlap ratio engine 1112 determines that the input blobs 1122, 1124 should be merged, the merge engine 1118 will merge the input blobs 1122, 1124, regardless of the results from the other engines 1114, 1116. As another example, when the merged size engine 1114 determines that the input blobs 1122, 1124 should not be merged, the merge engine 1118 will not merge the input blobs 1122, 1124, regardless of the results from the other engines 1112, 1116.

The output of the merge engine 1118 depends on whether the merge engine 1118 determined that input blobs 1122, 1124 should be merged. When the merge engine 1118 determined that the input blobs 1122, 1124 should not be merged, the merge engine 1118 will output BB1 1122, and BB2 1124, unchanged (or possibly with some information indicating that BB1 1122, and BB2 1124 have been tested for merging with each other). In such a case, the content-adaptive merge engine 1110 will add BB1 1122, and BB2 1124 to a list of output blobs 1120. When the merge engine 1118 determines that the input blobs 1122, 1124 should be merged, the merge engine 1118 will output a merged blob 1126. The content-adaptive merge engine 1110 will add the merged blob 1126 to the list of output blobs 1120. In this case, BB1 1122, and BB2 1124 are not added to the list of output blobs 1120, since these blobs 1122, 1124 now exist as part of the merged blob 1126.

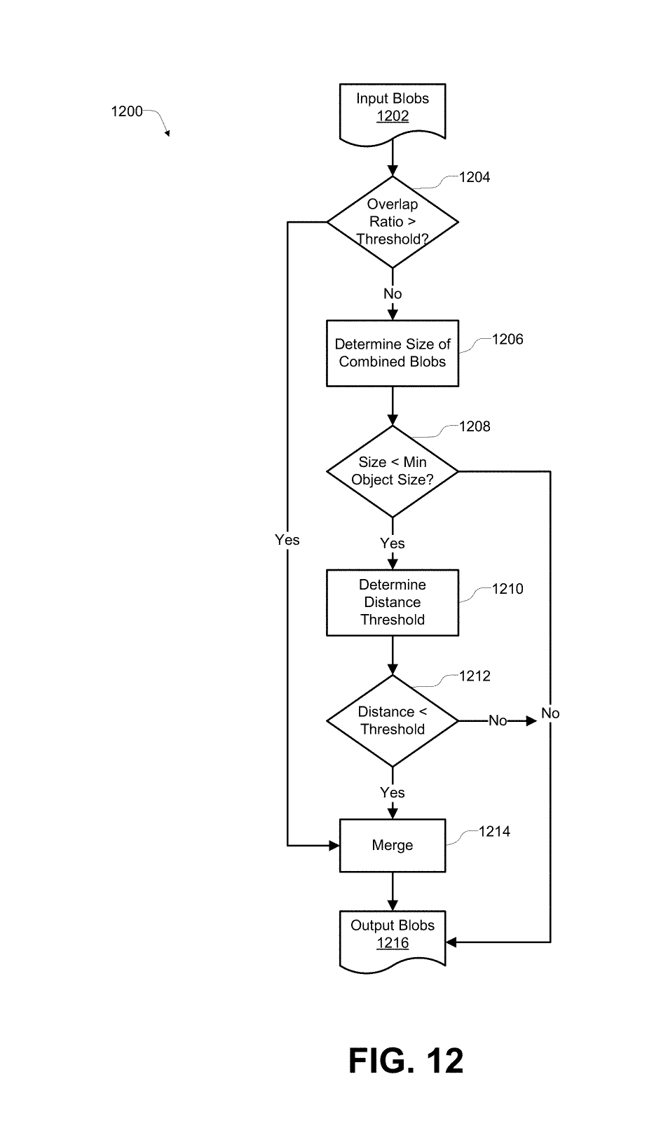

FIG. 12 illustrates an example of a process 1200 that a content-adaptive merge engine can use to determine whether to merge two bounding boxes. A content-adaptive merge engine receives a set of input blobs 1202 associated with a current input frame, and bounding boxes associated with the blobs. The blobs may have been derived by a blob analysis engine, which may have extracted foreground pixels, executed morphology operations on the foreground pixels, and then performed connected component analysis to determine the blobs. A processing engine may have then taken the blobs and produced bounding boxes for the blobs. Having receiving the blobs and their bounding boxes, the content-adaptive merge engine may process the blobs using the example process 1200.

Generally, the process 1200 uses an adaptation mechanism to check the spatial relationship and size information of two blobs to determine whether the two blobs should be merged. As discussed above, the process 1200 may consider all possible pairs of blobs in a list of input blobs 1202 one pair at a time. The process 1200 may terminate when, after testing each of the blobs in the list of input blobs 1202, no blobs are merged.

More specifically, at step 1204, the process 1200 considers the spatial layout of two blobs from the list of input blobs 1202. Considering the spatial layout includes considering the overlap ratio. When the overlap ratio is equal to or greater than an overlap threshold, the process 1200 determines that the blobs should be merged, and proceeds to step 1214. In some implementations, the overlap threshold is a fixed value. In some implementations, the overlap threshold is configured or adapted to the sizes of the objects typically found in a scene. For example, the threshold may be configured or adapted to assume that most objects in a scene are people or cars or some other object. At step 1214, the blobs are merged and added to the list of output blobs 1216.

Returning to step 1204, when the overlap ratio is less than the overlap threshold, the process 1200 proceeds to step 1206. At step 1206, the process 1200 determines the size of combined blobs. That is, the process 1200 determines, should the two input blobs be merged, what the size of the resulting merged blob would be. Stated differently, the process 1200 determines a candidate merged bounding box, where the candidate merged bounding box represents the bounding box that would result should the two input blobs be merged. The process 1200 can then determine the size of the candidate merged bounding box. In some implementations, the process 1200 determines the size of a new blob that combines the pixels of both the input blobs. In some implementations, the process 1200 determines the size of a bounding box for a new blob that results from combing the two input blobs. In some implementations, the process 1200 proceeds with the size of the combined blob. In some implementations, the process 1200 proceeds with the size of the bounding box for the combined blob.

At step 1208, the process 1200 determines whether the size of the combined blob (or the bounding box for the combined blob) is less than or equal to a size threshold. In various implementations, this size threshold is based on a minimum object size. For example, the size threshold can be set to the minimum object size, two times the minimum object size, four times the minimum object size, or some other integer or fractional multiple of the minimum object size. In various implementations, the minimum object size can be based on the size of the smallest object found in a previous frame. In various implementations, the minimum object size can be adjusted over time. For example, the minimum object size can be adjusted up or down as historical object sizes are determined over the course of multiple frames.

When the size of the combined blob (or its bounding box) is greater than the size threshold, the process 1200 determines that the two input blobs should not be merged. In this case, the process 1200 adds both input blobs to the list of output blobs 1216, unchanged. In various implementations, the blobs may include an indicator that indicates to the process 1200 that these particular two blobs have already been checked against each other for merging. In these implementations, the process 1200 can avoid checking them again on another iteration of the process 1200.

Returning to step 1208, when the size of the combined blob (or its bounding box) is less than the size threshold, the process 1200 proceeds to step 1210. At step 1210, the process 1200 determines a two-dimensional distance threshold, [DT_{X}, DT_{Y}]. In various implementations, the content-adaptive merge engine may initialize the distance threshold to a constant value, [C_{X}, C_{Y}]. In various implementations, the constant value may be configured according to the scene being viewed by a camera. For example, in indoor settings objects may be closer to the camera and thus appear larger. In these situations, the content-adaptive merge engine may be configured with a larger constant value. As another example, in outdoor settings such as a parking lot, objects may be further away and thus appear smaller. In these situations, the content-adaptive merge engine may be configured with a smaller constant value. In various implementations, [C_{X}, C_{Y}] can also be based on the particular use cases.

In various implementations, the process 1200 may, at step 1210, update the value of [DT_{X}, DT_{Y}]. In some implementations, the process 1200 may update the distance threshold using the following example equations:

$${DT}_{X} = \{ \begin{matrix}0 , & no overlap in Y dimension \\ {C}_{X} , & bundled size < 2 * min\_obj \_size \\ \frac{{C}_{X}}{4} , & otherwise\end{matrix} \\ {DT}_{Y} = \{ \begin{matrix}0 , & no overlap in X dimension \\ {C}_{Y} , & bundled size < 2 * min\_obj \_size \\ \frac{{C}_{Y}}{4} , & otherwise\end{matrix}$$

In the above example equations, the process 1200 uses zero for DT_{X} when the input blobs do not overlap in the vertical direction. That is, when the bounding boxes have no vertical overlap, the horizontal threshold is set to zero, and the bounding boxes will only be merged when their vertical edges align or overlap. Alternatively, the process 1200 uses constant value C_{X}, as described above, for DT_{X} when the “bundled size” (e.g., the size of the combine blob, should the two input blobs be merged) is less than two times the minimum object size. Alternatively, the process 1200 uses C_{X}/4 for DT_{X} when neither of the above conditions are true.

The process 1200 uses a similar process for determining a value to use for DT_{Y}. That is, the process 1200 uses zero for DT_{Y} when the input blobs do not overlap in the horizontal direction, meaning that the bounding boxes will be merged only when their horizontal edges align or overlap. Alternatively, the process uses C_{Y} when the “bundled size” is less than two times the minimum object size. Alternatively, the process 1200 uses C_{Y}/4 when neither of the above conditions are true.

In the above example equations, a multiplier of 2 and a divisor of 4 are provided as examples. In various implementations, the process 1200 may use a different multiplier or divisor, such as 1 and 2, respectively, or 4 and 8, respectively, or some other values. In various implementations the multiplier and/or divisor can be configured. For example, in some implementations, the values can be configured based on the particular scene being captured by a surveillance camera.

In various implementations, the process 1200 may further apply the following equations to obtain values for [DT_{X}, DT_{Y}]:

DTₓ=min(DT_{X},min(W_{b1},W_{b2}))

DT_{Y}=min(DT_{Y},min(H_{b1},H_{b2}))

In the above equations, the value of DT_{X} or DT_{Y} can be based on a previous value of DT_{X} or DT_{Y}. For example, DT_{X} can be selected from among the value of DT_{X} obtained from the previous frame, W_{b1}, or W_{b2}, where W_{b1} and W_{b} are the width of each of the input bounding boxes. Alternatively, DT_{X} can be selected from among the value of DT_{X} as provided by the three-part conditional equation described above, W_{b1}, or W_{b2}. Similarly, DT_{Y} can be selected from among the value of DT_{Y} (obtained from the previous frame or provided by the three-part conditional equation discussed above), H_{b1}, or H_{b2}, where H_{b1} and H_{b2} are the height of the each of the input bounding boxes. In some implementations, instead of using the minimum width and height of the input bounding boxes, the process 1200 may use the smallest width and height of all bounding boxes detected so far for the scene. In some implementations, the distance threshold may become smaller, over time, and the occurrences of merges should correspondingly decrease.

At step 1212, having established the distance threshold, the process 1200 next determines whether the distances between the input bounding boxes are less than or equal to the distance threshold. When the distances between the input bounding boxes are below the distance threshold, the process 1200 proceeds to step 1214 and merges the bounding boxes. The merged blob is then added to the list of output blobs 1216. In some implementations, both the horizontal and the vertical distances must be below the respective thresholds for the bounding boxes to be merged. In some implementations, only one distance, vertical or horizontal, needs to be below the threshold. For example, when the input bounding boxes overlap in the horizontal direction, the process only considers the vertical distance between the input bounding boxes. Similarly, when the input bounding boxes overlap in the vertical direction, the process 1200 only considers the horizontal distance between the input bounding boxes. Having merged the bounding boxes at step 1214, the process 1200 adds the resulting merged blob to the output blobs 1216. The input blobs are not added back to list of output blobs 1216.

Returning to step 1212, when the distances between the input bounding boxes are greater than the distance threshold, the process 1200 determines that the bounding boxes should not be merged. The process 1200 then adds the input bounding boxes, unchanged, to the list of output blobs 1216.

As noted above, the process 1200 can be executed for each pair of blobs in the list of input blobs 1202. Once each possible pair of blobs has been considered, the process 1200 may then repeat, using the list of output blobs 1216 as the list of input blobs 1202. In this way, an object that has been identified as more than two blobs can be merged into one blob.

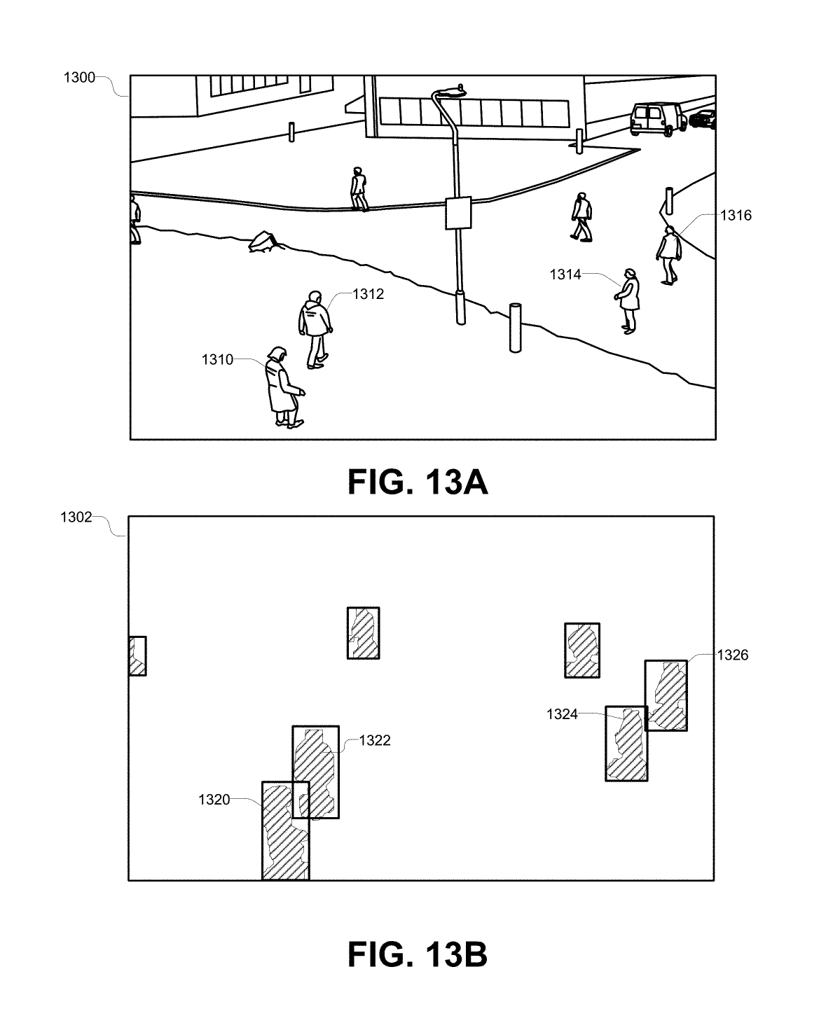

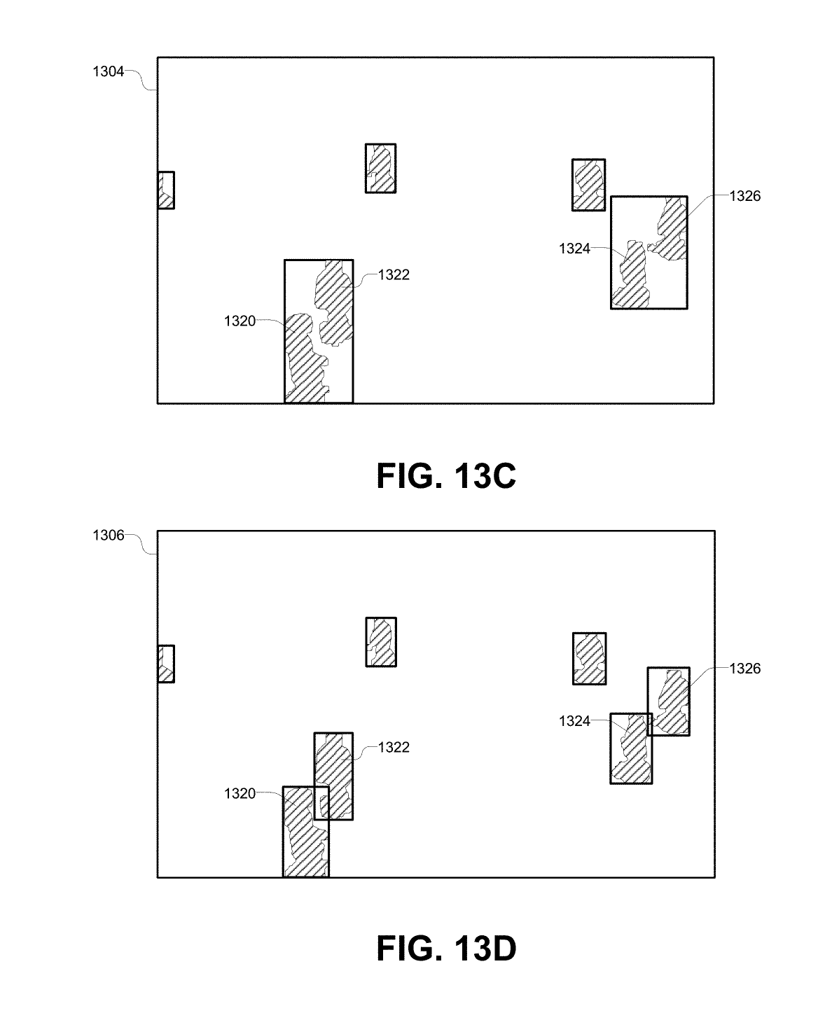

FIG. 13A-FIG. 13D illustrate an example comparing the result from a bounding box merge process that uses fixed thresholds, and the result from a content-adaptive bounding box merge process. FIG. 13A illustrates an example of a video frame 1300 in which moving objects are being tracked using a video content analysis system. In the scene, multiple people 1310, 1312, 1314, 1316 are moving about. In this example video frame 1300, two people 1310, 1312 near the bottom of the frame 1300 happen to be walking near to each other. Near the right edge of the frame 1300, two other people 1314, 1316 are not necessarily near to each other in three-dimensional space, but in the two-dimensional space of the video frame 1300 the two people 1314, 1316 appear close to each other. A blob analysis system may identify one blob for each of the people 1310, 1312, 1314, 1316 in the two groups, but with overlapping bounding boxes.

FIG. 13B illustrates an example of a video frame 1302 that includes only the blobs that may be determined for the objects in the video frame 1300 of FIG. 13A that are identified as foreground objects. The video frame 1302 of FIG. 13B also includes the bounding boxes for the blobs. In this example video frame 1302, it can be seen that the blobs 1320, 1322 for the two people 1310, 1312 near the bottom of the frame 1302 overlap. Similarly, the bounding boxes for the blobs 1324, 1326 for the two people 1314, 1316 near the right edge of the frame 1302 also overlap.

FIG. 13C illustrates an example of a video frame 1304 that includes the blobs determined for the video frame 1300 of FIG. 13A, as well as the bounding boxes that may be determined after a merge process has merged the bounding boxes for the blobs. As illustrated in FIG. 13B, the bounding boxes for the blobs 1320, 1322 near the bottom of the frame 1302 overlap. In example of FIG. 13C, a fixed threshold merge process was used. This process determined that both the blobs 1320, 1322 near the bottom of the frame 1302 represent one object, likely due to the overlap ratio of the bounding boxes for the blobs 1320, 1322 being less than the fixed threshold. The video frame 1304 thus includes one, merged bounding box 1330 for this pair of blobs 1320, 1322. Similarly, using a fixed threshold (such as an overlap threshold or a distance threshold), the process determined that the blobs 1324, 1326 near the right edge of the frame 1304 also have sufficient overlap. Thus, the frame 1304 includes one bounding box 1332 for this pair of blobs 1324, 1326.

As can be seen in the original video frame 1300, however, the blobs 1320, 1322, 1324, 1326 are individual people, and their bounding boxes should not have been merged. In various implementations, a video content analysis system may use a content-adaptive merge process, rather than a fixed threshold merge process, to produce a more accurate merge result.

FIG. 13D illustrates an example of a video frame 1306 that includes the blobs determined from the video frame 1300 in FIG. 13A, and the bounding boxes that may be determined after a content-adaptive bounding box merge process has examined the blobs. In the example of FIG. 13D, nether the blobs 1320, 1322 near the bottom of the frame 1306, nor the blobs 1322, 1324 near the right edge of the frame 1306 have been merged. In various implementations, the content-adaptive merge process may have determined a minimum reasonable object size that—since the scene captures people moving about—roughly corresponds to the size of a person. The content-adaptive merge process may further have determined that, though the bounding boxes for the blobs 1320, 1322 near the bottom of the frame 1306 overlap, a resulting merged bounding box would exceed the minimum reasonable object size. The content-adaptive merge process may thus have determined to not merge the bounding boxes for these blobs 1320, 1322. Similarly, the content-adaptive merge process may have determined that merging the two blobs 1324, 1326 near the right edge of the frame 1306 would also have resulted in a merged bounding box that would exceed the minimum reasonable object size. Thus, these two blobs 1324, 1326 have also not been merged.

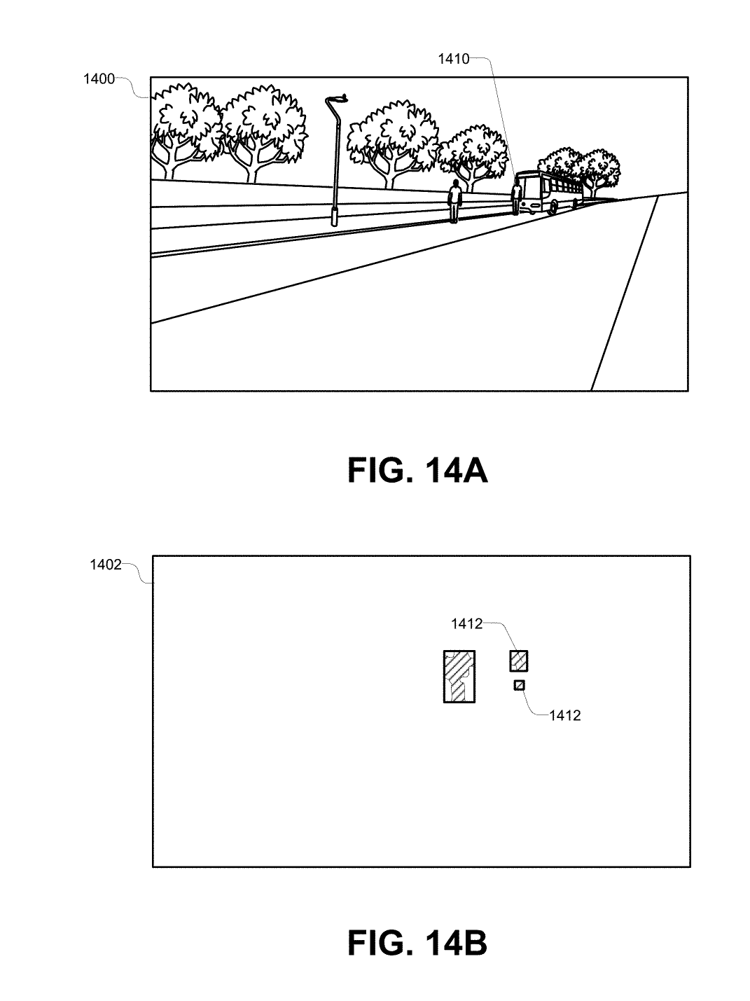

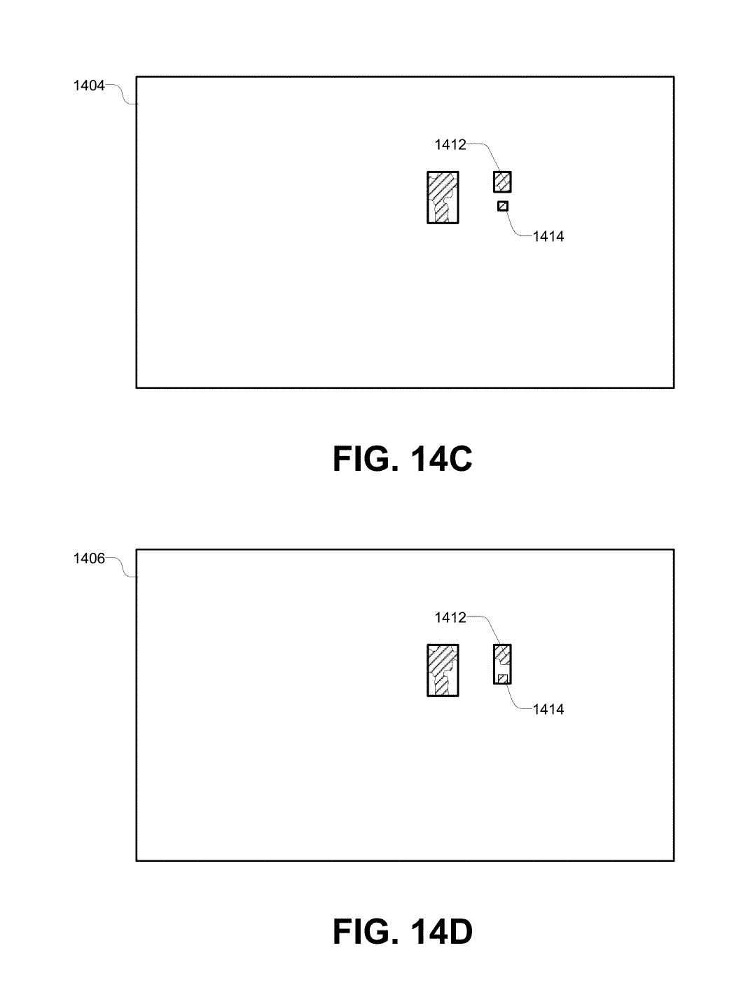

FIG. 14A-FIG. 14D illustrate another example comparing the result from a bounding box merge process that uses fixed thresholds and the result from a content-adaptive bounding box merge process. FIG. 14A illustrates an example of a video frame 1400 in which moving objects are being tracked. In this frame, a person 1410 is walking in front of a stationary bus. The person 1410 is fairly far from the camera, and thus may be represented by only a handful of pixels.

FIG. 14B illustrates an example of a video frame 1402 that includes only the blobs that were determined for the video frame 1400 of FIG. 14A. The video frame 1402 of FIG. 14B also include the bounding boxes that may be determined for the blobs. In the example video frame 1402, the blob analysis system has detected the person 1410 in front of the bus as two blobs 1412, 1414, possibly because the person 1410 is so far from the camera and thus registers as only a few pixels, or because the person's clothing blends with the colors of the bus, or for some other reasons, or for a combination of reasons.

FIG. 14C illustrates an example of a video frame 1404 that includes the blobs determined for the video frame 1400 of FIG. 14A, as well as the bounding boxes that may be determined by a merge process that uses a fixed threshold. In the example frame 1404 of FIG. 14C, the two blobs 1412, 1414 for the person 1410 walking in front of the bus have not been merged. The merge process likely determined that, because the two blobs 1412, 1414 do not overlap, that the blobs 1412, 1414 should not be merged. As a result, the person 1410 may be tracked as two objects instead of one.

FIG. 14D illustrates an example of a video frame 1406 that includes the blobs determined for the video frame 1400 of FIG. 14A, as well as the bounding boxes that may be determined by a content-adaptive bounding box merge process. In the example video frame 1406 of FIG. 14D, the two blobs 1412, 1414 for the person 1410 in front of the bus have been merged. The content-adaptive merge process may have determined that the bounding boxes for the two blobs 1412, 1414 overlap horizontally, and, though the bounding boxes do not overlap vertically, that the vertical distance between the bounding boxes is below a threshold. The content-adaptive merge process may further have determined that the resulting merged bounding box 1430 is less than, for example, two times the minimum reasonable object size.

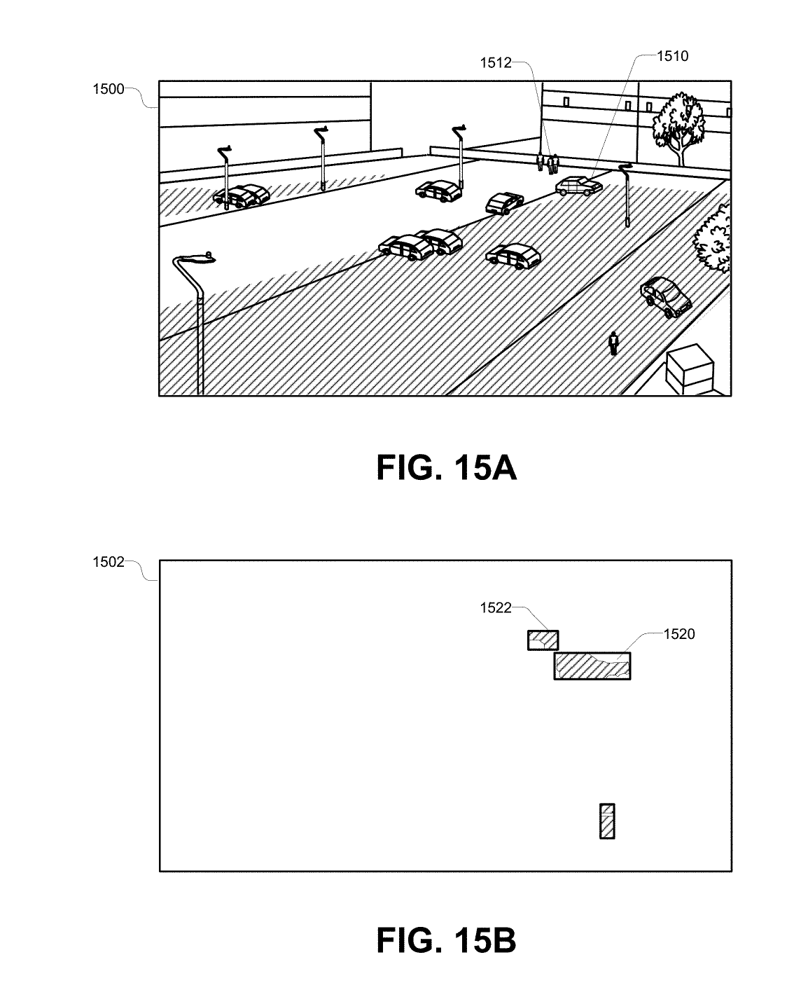

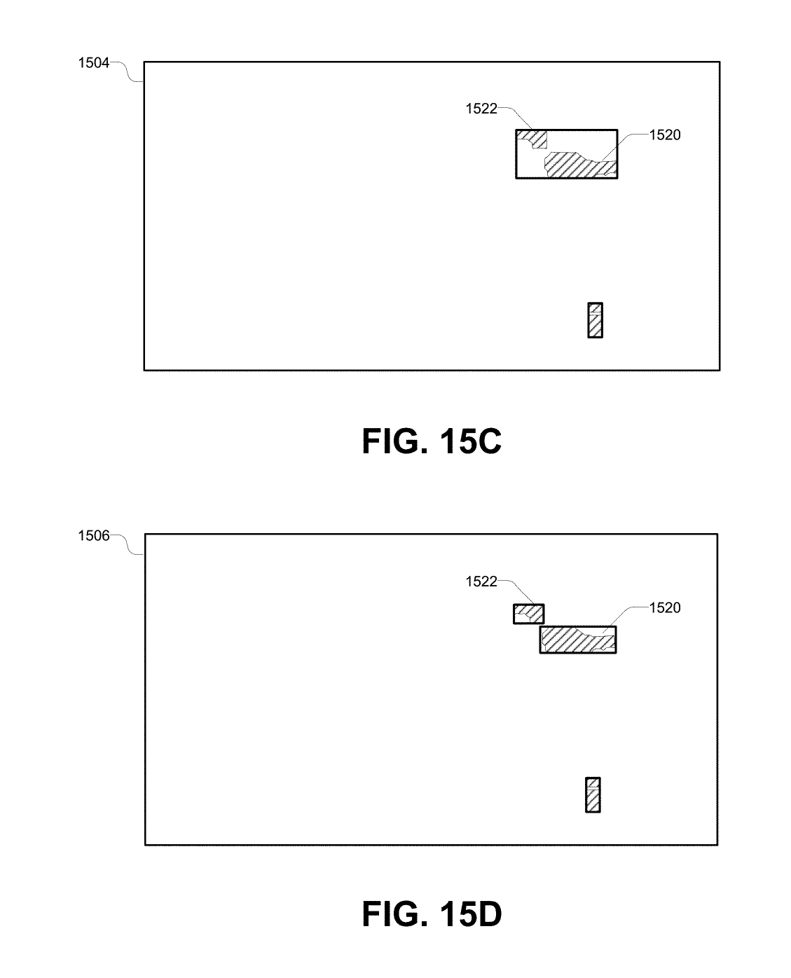

FIG. 15A-FIG. 15D illustrate another example comparing the result from a bounding box merge process that uses thresholds and the result from a content-adaptive bounding box merge process. FIG. 15A illustrates an example of a video frame 1500 in which moving objects are being tracked. The captured scene is of a parking lot, where cars are moving about. In the upper-right corner of the frame, a car 1510 is exiting the parking lot not too far from where a group of people 1512 is walking.

FIG. 15B illustrates an example of a video frame 1502 that includes only the blobs determined for the video frame 1500 of FIG. 15A. The video frame 1502 of FIG. 15B also includes the bounding boxes determined for the blobs. As illustrated in the example video frame 1502, a blob analysis system has determined one large blob 1520 for the car 1510, and one smaller blob 1522 for the group of people 1512. The blobs 1520, 1522 do not overlap, but are very close to each other.

FIG. 15C illustrates an example of a video frame 1504 that includes the blobs for the video frame 1500 of FIG. 15A, as well as the bounding boxes that may be determined by a merge process that uses a fixed threshold. In the example frame 1504 of FIG. 15C, the blob 1520 for the car 1510 and the blob 1522 for the group of people 1512 do not overlap, but a merge process that considers a fixed distance threshold may determine that the blobs 1520, 1522 are close enough to each other to be merged. The merge process likely did not consider the relative sizes of the blobs 1520, 1522 to each other, or the size of the resulting merged bounding box 1530.

FIG. 15D illustrates an example of a video frame 1506 that includes the blobs for the video frame 1500 of FIG. 15A, as well as the bounding boxes that may be determined by a content-adaptive bounding box merge process. In the example frame 1506 of FIG. 15D, the blob 1520 for the car 1510 has not been merged for the blob 1522 for the group of people 1512. The content-adaptive merge process may have determined a minimum reasonable object size that approximates the size of a person, or that is somewhere between the size of a person and the size of a car. The process may further have determined that merging the blob 1520 for the car 1510 and the blob 1522 for the group of people 1512 would result in a merged bounding box that exceeds the minimum reasonable object size. The content-adaptive bounding box merge process thus produced a more accurate result.

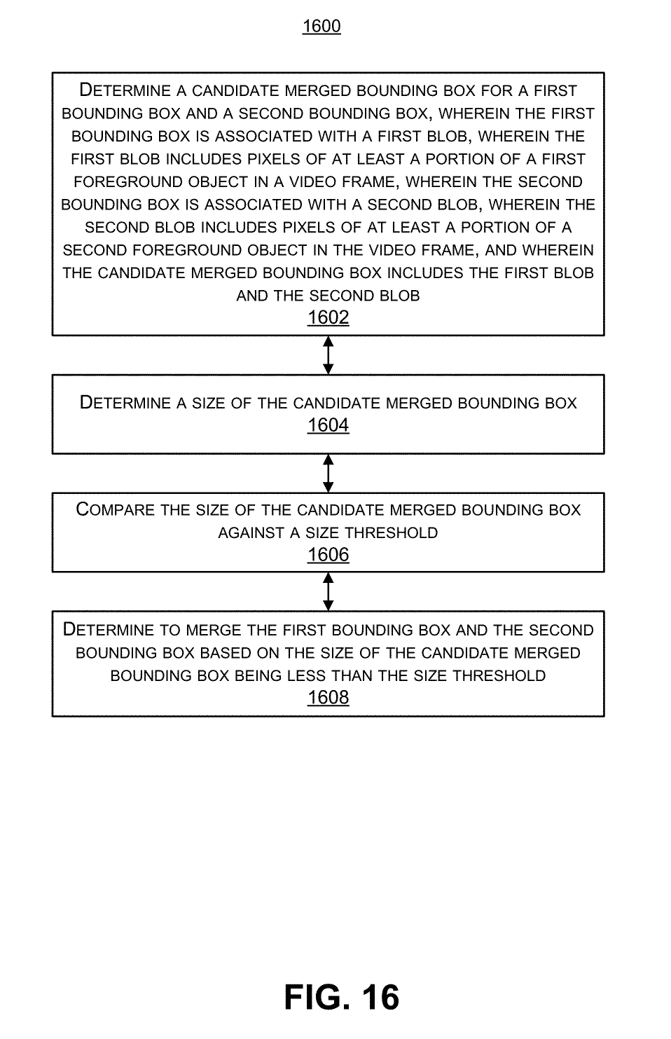

FIG. 16 illustrates an example of a process 1600 for content adaptive merging of bounding boxes. At 1602, the process 1600 includes determining a candidate merged bounding box for a first bounding box and a second bounding box, wherein the first bounding box is associated with a first blob, wherein the first blob includes pixels of at least a portion of a first foreground object in a video frame, wherein the second bounding box is associated with a second blob, wherein the second blob includes pixels of at least a portion of a second foreground object in the video frame, and wherein the candidate merged bounding box includes the first blob and the second blob. In various implementations, the candidate merged bounding box is the bounding box that would result should the first bounding box and the second bounding box be merged. In some cases, the first bounding box and the second bounding box have an intersecting region and a non-intersecting region. In some cases, the first bounding box overlaps vertically, but not horizontally, with the second bounding box. In some cases, the first bounding box overlaps horizontally, but not vertically, with the second bounding box. In some cases, the first bounding box and the second bounding box do not overlap in either the horizontal or the vertical directions. In some cases, the first bounding box and the second bounding box overlap in both the vertical and horizontal directions.

At 1604, the process 1600 includes determining a size of the candidate merged bounding box. In various implementations, the size of the candidate merged bounding box may be based on the number of pixels included within the candidate merged bounding box. For example, the size of the candidate merged bounding box may the area, in pixels, enclosed by the candidate merged bounding box. In various implementations, the size of the candidate merged bounding box may be based on the number of pixels in the first blob and the second blob that result when the first blob and the second blob are merged (that is, the number of pixels included in the union of the first blob and the second blob).

At 1606, the process 1600 includes comparing the size of the candidate merged bounding box against a size threshold. In some implementations, the size threshold is a multiple of a minimum object size. In some implementations, the minimum object size is determined using historical bounding box sizes. For example, the process 1600 may store the sizes of bounding boxes seen in past video frames, and from this historical information determine a minimum reasonable size for bounding boxes that will be seen in future video frames. In some implementations, the minimum object size is configurable.

At 1608, the process 1600 includes determining to merge the first bounding box and the second bounding box based on the size of the candidate merged bounding box being less than the size threshold. Thereafter, in some cases, the first bounding box and the second bounding box may be treated as one bounding box, and the blob in the first bounding box and the blob in the second bounding box may be treated as one blob.

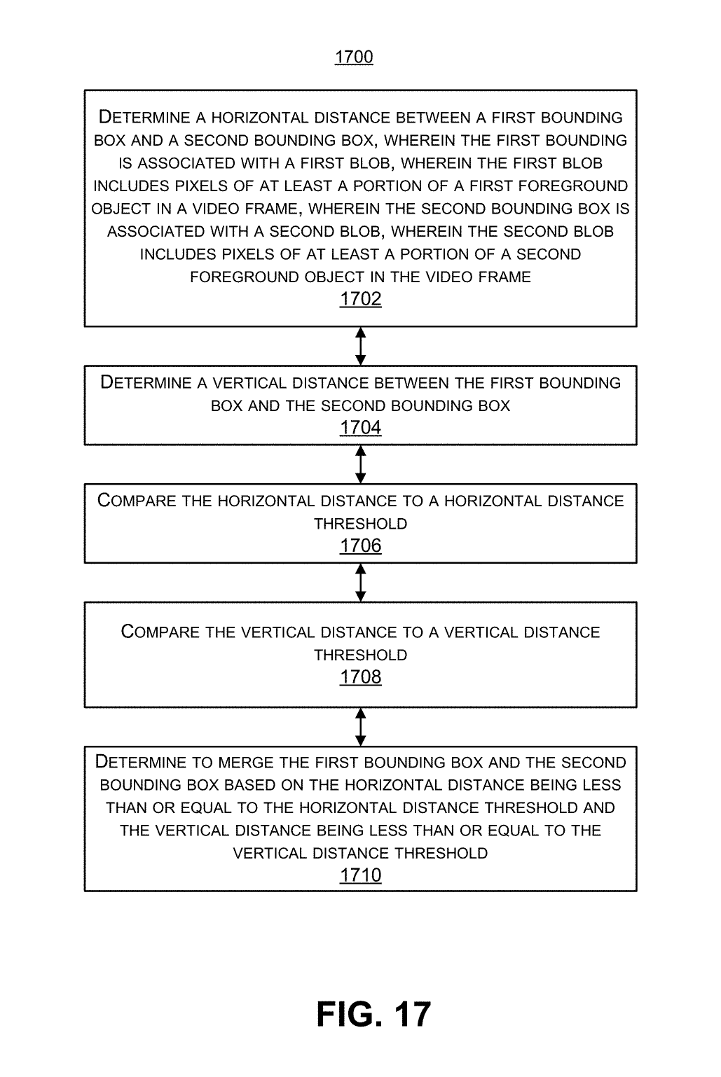

FIG. 17 illustrates an example of a process 1700 for content adaptive merging of bounding boxes. At 1702, the process 1700 includes determining a horizontal distance between a first bounding box and a second bounding box, wherein the first bounding box is associated with a first blob, wherein the first blob includes pixels of at least a portion of a first foreground object in a video frame, wherein the second bounding box is associated with a second blob, and wherein the second blob includes pixels of at least a portion of a second foreground object in the video frame. In some implementations, the horizontal distance is determined by taking the difference between the horizontal coordinate of the vertical edge of the first bounding box that is closest to the second bounding box, and the horizontal coordinate of the vertical edge of the second bounding box that is closest to the first bounding box. In some cases, such as when the first bounding box and the second bounding box overlap in the horizontal direction, the difference is less than zero. In some implementations, when the horizontal distance between the first bounding box and the second bounding box is less than zero, the process 1700 may treat the horizontal distance as zero.

At 1704, the process 1700 includes determining a vertical distance between the first bounding box and the second bounding box. In some implementations, the vertical distance is determined by taking the difference between the location of the horizontal edge of the first bounding box that is nearest to the second bounding box. In some implementations, such as when the first bounding box overlaps with the second bounding box in the vertical direction, the difference may be less than zero. In some implementations, the process 1700 treats a vertical distance that is less than zero as zero.

At 1706, the process 1700 includes comparing the horizontal distance to a horizontal distance threshold. In some implementations, the horizontal distance threshold is zero when the first bounding box and the second bounding box do not vertically overlap. In some implementations, the horizontal distance threshold is a horizontal constant when the size of the merged bounding box is less than or equal to a multiple of the size threshold. In some implementations, the horizontal distance threshold is a fraction of the horizontal constant when the first bounding box and the second bounding box vertically overlap and the size of the merged bounding box is greater than the multiple of the size threshold. In some implementations, the process 1700 includes determining the horizontal distance threshold. In these implementations, determining the horizontal distance threshold includes selecting a minimum value from among a previous value of the horizontal distance threshold, the width of the first bounding box, and the width of the second bounding box.

At 1708, the process 1700 includes comparing the vertical distance to a vertical distance threshold. In some implementations, the vertical distance threshold is zero when the first bounding box and the second bounding box do not horizontally overlap. In some implementations, the vertical distance threshold is a vertical constant when the size of the merged bounding box is less than or equal to a multiple of the size threshold. In some implementations, the vertical distance threshold is a fraction of the vertical constant when the first bounding box and the second bounding box horizontally overlap and the size of the merged bounding box is greater than the multiple of the size threshold. In some implementations, the process 1700 includes determining the vertical distance threshold. In these implementations, determining the vertical distance threshold includes selecting a minimum value from among a previous value of the vertical distance threshold, a height of the first bounding box, and a height of the second bounding box.

At 1710, the process 1700 includes determining to merge the first bounding box and the second bounding box based on the horizontal distance being less than or equal to the horizontal distance threshold and the vertical distance being less than or equal to the vertical distance threshold. In some cases, the horizontal distance is less than zero, in which case the process 1700 may treat the horizontal distance as zero. In some implementations, when the horizontal distance is less than or equal to zero (or treated as zero), the process 1700 may use zero as the horizontal distance threshold. In some cases, the vertical distance is less than or equal to zero, in which case the process 1700 may treat the vertical distance as zero. In some implementations, when the vertical distance is less than or equal to zero (or treated as zero), the process 1700 may use zero as the vertical distance threshold. In various implementations, merging the first bounding box and the second bounding box includes generating a merged bounding box, where the merged bounding box includes the blob associated with the first bounding box and the blob associated with the second bounding box. Once the bounding boxes are merged, the two blobs may be treated as one blob going forward.

In some examples, the processes 1600 and 1700 may be performed by a computing device or an apparatus, such as the video analytics system 100. For example, the processes 1600 and 1700 can be performed by the video analytics system 100 and/or the object tracking engine 106 shown in FIG. 1. In some cases, the computing device or apparatus may include a processor, microprocessor, microcomputer, or other component of a device that is configured to carry out the steps of processes 1600, 1700. In some examples, the computing device or apparatus may include a camera configured to capture video data (e.g., a video sequence) including video frames. For example, the computing device may include a camera device (e.g., an IP camera or other type of camera device) that may include a video codec. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Processes 1600, 1700 are illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes 1600, 1700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The content-adaptive blob tracking operations discussed herein may be implemented using compressed video or using uncompressed video frames (before or after compression). An example video encoding and decoding system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

In the foregoing description, aspects of the application are described with reference to specific embodiments thereof, but those skilled in the art will recognize that the invention is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method for merging bounding boxes, comprising:
determining a candidate merged bounding box for a first bounding box and a second bounding box, wherein the first bounding box is associated with a first blob, wherein the first blob includes pixels of at least a portion of a first foreground object in a video frame, wherein the second bounding box is associated with a second blob, wherein the second blob includes pixels of at least a portion of a second foreground object in the video frame, and wherein the candidate merged bounding box includes the first blob and the second blob;
determining a size of the candidate merged bounding box;
comparing the size of the candidate merged bounding box against a size threshold; and
determining to merge the first bounding box and the second bounding box based on the size of the candidate merged bounding box being less than the size threshold.

2. The method of claim 1, further comprising:
determining that the first bounding box and the second bounding box have an intersecting region and a non-intersecting region;
determining a ratio between an area of the non-interesting region and the intersecting region; and
comparing the ratio to an overlap threshold;
wherein the size of the candidate merged bounding box is determined when the ratio is less than the overlap threshold.

3. The method of claim 1, further comprising:
determining a first distance between the first bounding box and the second bounding box; and
comparing the first distance to a first distance threshold;
wherein determining to merge the first bounding box and the second bounding box is further based on the first distance being less than or equal to the first distance threshold.

4. The method of claim 3, wherein the processor is further configured to:
determine a second distance between the first bounding box and the second bounding box, wherein the second distance is orthogonal to the first distance; and
compare the second distance to a second distance threshold;
wherein determining to merge the first bounding box and the second bounding box is further based on the second distance being less than or equal to the second distance threshold.

5. The method of claim 3, wherein the first distance is a horizontal distance, and wherein the first distance threshold is a horizontal distance threshold.

6. The method of claim 1, wherein the size threshold is a multiple of a minimum object size.

7. An apparatus, comprising:
a memory configured to store video data; and
a processor configured to:
determine a candidate merged bounding box for a first bounding box and a second bounding box, wherein the first bounding box is associated with a first blob, wherein the first blob includes pixels of at least a portion of a first foreground object in a video frame, wherein the second bounding box is associated with a second blob, wherein the second blob includes pixels of at least a portion of a second foreground object in the video frame, and wherein the candidate merged bounding box includes the first blob and the second blob;
determine a size of the candidate merged bounding box;
compare the size of the candidate merged bounding box against a size threshold; and
determine to merge the first bounding box and the second bounding box based on the size of the candidate merged bounding box being less than the size threshold.

8. The apparatus of claim 7, where the process is further configured to:
determine that the first bounding box and the second bounding box have an intersecting region and a non-intersecting region;
determine a ratio between an area of the non-interesting region and the intersecting region; and
compare the ratio to an overlap threshold;
wherein determining to merge the first bounding box and the second bounding box is further based on the ratio being less than the overlap threshold.

9. The apparatus of claim 7, wherein the processor is further configured to:
determine a first distance between the first bounding box and the second bounding box; and
compare the first distance to a first distance threshold;
wherein determining to merge the first bounding box and the second bounding box is further based on the first distance being less than or equal to the first distance threshold.

10. The apparatus of claim 9, wherein the first distance is a horizontal distance, wherein the first distance threshold is a horizontal distance threshold, wherein the horizontal distance threshold is zero when the first bounding box and the second bounding box do not vertically overlap, wherein the horizontal distance threshold is a horizontal constant when the size of the candidate merged bounding box is less than or equal to a multiple of the size threshold, and wherein the horizontal distance threshold is a fraction of the horizontal constant when the first bounding box and the second bounding box vertically overlap and the size of the candidate merged bounding box is greater than the multiple of the size threshold.

11. The apparatus of claim 9, wherein the first distance is a horizontal distance, wherein the first distance threshold is a horizontal distance threshold, and wherein the processor is further configured to:
determine the horizontal distance threshold, wherein the determining includes selecting a minimum value from among of a previous value of the horizontal distance threshold, a width of the first bounding box, and a width of the second bounding box.

12. The apparatus of claim 9, wherein the first distance is a vertical distance, where the first distance threshold is a vertical distance threshold, wherein the vertical distance threshold is zero when the first bounding box and the second bounding box do not horizontally overlap, wherein the vertical distance threshold is a vertical constant when the size of the candidate merged bounding box is less than or equal to a multiple of the size threshold, and wherein the vertical distance threshold is a fraction of the vertical constant when the first bounding box and the second bounding box horizontally overlap and the size of the candidate merged bounding box is greater than the multiple of the size threshold.

13. The apparatus of claim 9, wherein the first distance is a vertical distance, where the first distance threshold is a vertical distance threshold, and wherein the processor is further configured to:
determine the vertical distance threshold, wherein the determining includes selecting a minimum value from among a previous value of the vertical distance threshold, a height of the first bounding box, and a height of the second bounding box.

14. The apparatus of claim 7, wherein the size threshold is a multiple of a minimum object size.

15. The apparatus of claim 14, wherein the minimum object size is determined using historical bounding box sizes.

16. The apparatus of claim 14, wherein the minimum object size is configurable.

17. A computer-readable medium having stored thereon instructions that, when executed by a processor, perform a method, the method including:
determining a candidate merged bounding box for a first bounding box and a second bounding box, wherein the first bounding box is associated with a first blob, wherein the first blob includes pixels of at least a portion of a first foreground object in a video frame, wherein the second bounding box is associated with a second blob, wherein the second blob includes pixels of at least a portion of a second foreground object in the video frame, and wherein the candidate merged bounding box includes the first blob and the second blob;
determining a size of the candidate merged bounding box;
comparing the size of the candidate merged bounding box against a size threshold; and
determining to merge the first bounding box and the second bounding box based on the size of the candidate merged bounding box being less than the size threshold.

18. The computer-readable medium of claim 17, the method further comprising:
determining that the first bounding box and the second bounding box have an intersecting region and a non-intersecting region;
determining a ratio between an area of the non-interesting region and the intersecting region; and
comparing the ratio to an overlap threshold;
wherein determining to merge the first bounding box and the second bounding box is further based on the ratio being less than the overlap threshold.

19. The computer-readable medium of claim 17, the method further comprising:
determining a first distance between the first bounding box and the second bounding box; and
comparing the first distance to a first distance threshold;
wherein determining to merge the first bounding box and the second bounding box is further based on the first distance being less than or equal to the first distance threshold.

20. The computer-readable medium of claim 17, wherein the size threshold is a multiple of a minimum object size.
